(19) United States
(12) Patent Application Publication
(10) Pub. No.: US 2005/0059779 A1
(43) Pub. Date: Mar. 17, 2005

(54) Olefin-hydrophilic block copolymers of controlled sizes and methods of making and using the same

(75) Inventors: Han-Ting Chang, Livermore, CA (US); Dominique Charmot, Campbell, CA (US); Damian Hajduk, San Jose, CA (US); Manikandan Jayaraman, San Francisco, CA (US); Florence Roger, Santa Clara, CA (US); Victor Nava-Salgado, San Jose, CA (US); Adam Safir, Berkeley, CA (US)

Correspondence Address: SYMYX TECHNOLOGIES INC;LEGAL DEPARTMENT, 3100 CENTRAL EXPRESS, SANTA CLARA, CA, 95051, US

(73) Assignee: Symyx Technologies, Inc.

(21) Appl. No.: 10/689,775

(22) Filed: Oct. 20, 2003

Related U.S. Application Data
(60) Provisional application No. 60/419,951, filed on Oct. 21, 2002.

(51) Int. Cl. C08L 53/00

(52) U.S. Cl. 525/88; 525/163

(57) ABSTRACT

A method for controlling the size of the blocks in a bock copolymer having an olefinic block and a hydrophilic block is disclosed. The method results in block copolymers having novel properties, including the ability to increase the wetability of an olefinic substrate.

### FIELD OF THE INVENTION

The present invention relates to new polymers, methods of making those polymers and methods of using those polymers. This invention relates to block copolymers where at least one block is made of a polyolefin segment and the other block is hydrophilic in nature. For example, the polymers may be block copolymers of ethylene and hydrophilic monomers, most preferably vinyl acetate and acrylate type monomers, having blocks of controlled size, and optionally including other blocks of monomers (the same or different monomers) in the polymer. The process is a living free radical polymerization, based on reversible addition fragmentation transfer. The block copolymer materials have application in hydrophilization of low surface energy substrates such as polyolefins (e.g., ethylene, propylene, other α-olefins, and their copolymers) to confer better adhesion and other attributes to those surfaces (such as improved dyebility and printability), compatibilization additive for polyolefin blends, pigment dispersion additives in inks and coatings. Conversely they can be used to make polar surfaces hydrophobic and provide properties such as water resistance or anti-adhesion.

### BACKGROUND OF THE INVENTION

Polyolefin materials, such as polyethylene or polypropylene, have significant commercial value in view of their use in a wide variety of applications. However, adhesion of other materials to polyolefin materials (such as paints or other coatings) is still a subject of investigation in order to improve dying, printing and painting processes and as well as coating integrity and durability. Known processes include corona treatment and primer coating, but such known processes are not particular effective, with coatings still detaching from the polyolefin materials. Also known are chlorinated polyolefins, such as chlorinated polypropylene, but such polymers are expensive, have limited stability and cause environmental problems. In particular, for primers, there is a need for more commercially acceptable polymers that adhere to polyolefin materials while providing a sufficient level of compatibility with paint or printing ink binder materials.

Many block copolymers have been described in the literature, see, for example the recently published application EP 1172407. However, none of these references specifically describe a block copolymer with a polyethylene block associated with a polar hydrocarbon backbone that are prepared with a polymerization process that controls block sizes in a commercially acceptable manner.

For instance styrenic copolymers, such as SBS or SIS copolymers, are known. These polymers are made by sequential anionic polymerization of styrene butadiene and isoprene. Although it is possible to hydrogenate the polydiene block to form a polyolefin block, it is virtually impossible to incorporate polar monomer units with —OH, —NH₂ or —COOH functional groups to produce block copolymers with an amphiphilic character.

Several living free radical polymerization techniques are now used to make block copolymers. See e.g., U.S. Pat. No. 6,153,705 claiming block copolymers made using a controlled polymerization method. However, none of these methods are today implemented at a commercial scale (in Controlled/Living Radical Polymerization, ACS series 768, K. Matyjaszeski Ed., 2000). There is also no report of a free radical polymerization process which produces a block copolymer with a polyolefin segment such as polyethylene, together with a polar group, and even less knowledge exists regarding the use of such a copolymer to impart better adhesion onto polyolefin substrates.

Other techniques describe the synthesis of block copolymers incorporating ethylene and propylene and a polar polymeric segment such as polyethylene glycol, or polymethylmethacrylate. See e.g., Allgaier et al., Macromolecules, 1997, 30, 1852; Bergbreiter et al., Macromolecules, 1998, 36, 803; and Chung et al., Macromolecules, 1994, 27, 26. These approaches are academically interesting because they require synthesis conditions (anionic or metal mediated polymerizations) that are generally incompatible with commercially acceptable costs for adhesion promoters. Copolymer of ethylene and vinyl acetate (EVA's) are sometime incorrectly termed “blocky”, especially when these copolymers prepared by free radical techniques. Those of skill in the art generally understand these EVA's to not be true “block” copolymers, e.g., not having a A-B or A-B-A type structure. Thus, these EVA's tend to have limited vinyl acetate percentages and different properties from the polymers of this invention, such as different wetting properties of polyolefin substrates and different coating abilities. In generally, known EVA's, including “blocky” polymers are incapable of coating a polyolefin substrate with a commercially acceptable amount of adhesion. Also, known EVA's with more than 40% vinyl acetate are typically amorphous without a measurable polyolefinic crystalline block in the backbone.

Another well-known technique is to modify polyethylene or polypropylene by reactive extrusion using a radically polymerizable monomer and a free radical initiator at high temperature in a screw extruder. The material derived from reactive extrusion is however not well defined structurally because of side reactions that occur during the extrusion process (such as cross-linking or chain scission). Also the numbers of grafted monomer units per pendant graft is very low, and cannot be considered as a polymer chain; for example, consider G. Moad, Prog. Polym. Sci, 24 (1999), 81-142.

This invention solves these issues by providing a block copolymer, method of making and use that demonstrably promoted better coating of polyolefin substrates.

### SUMMARY OF THE INVENTION

This invention discloses block copolymers with at least one segment capable of adhering to a polyolefin surface, connected to polymeric segments that have high affinity (or at least miscibility) with typical polar polymeric binders used in coatings and inks. The polymer block or segment that exhibits high affinity to a polyolefin surface is itself an olefin polymer or copolymer. The other non-olefinic polymer segment comprises a polar polymeric backbone produced by free radical polymerization of ethylenically unsaturated polar monomers. The block copolymers of the invention are prepared by sequential living free radical polymerization, using reversible addition-fragmentation transfer agents.

Thus in some embodiments, this invention is directed toward a method of preparing a block copolymer having at least one hydrophilic block and one olefinic block. The term hydrophilic is used relative to the hydrophobic nature of the olefinic block. In this context, the method comprises polymerizing a liquid hydrophilic monomer under polymerization conditions, with the polymerization conditions including use of a control agent (or a chain transfer agent) that has a dithio-moiety. The process results in first polymerizing in a controlled manner the at least one hydrophilic block and allowing for optional isolation of a “living” hydrophilic block, meaning a hydrophilic block with the control agent or chain transfer agent attached. The process further comprises subsequently reacting the at least one hydrophilic block with an olefin monomer capable of free radical polymerization under polymerization conditions to form the at least one olefinic block.

In some embodiments, the invention is directed toward a method of preparing a block copolymer, by first polymerizing a diene monomer by emulsion polymerization using a RAFT dithio control agent, then chain extending with a hydrophilic monomer. The block copolymer is then isolated and hydrogenated to convert the polydiene block into an ethylene/alpha-olefin copolymer block.

Using these processes, block copolymers of this invention are prepared, with the block copolymer having properties that are tunable for certain applications. For some embodiments, when the copolymer is applied to an olefinic substrate, the surface tension of the olefinic substrate can be changed by an amount between about 10 and about 50 mN/m.

In other embodiments of this invention, specific control agents or chain transfer agents are used. In still other embodiments of this invention, copolymers are prepared having novel properties.

Thus, it is an object of this invention to provide a block copolymer comprising at least one block that has a high affinity for adhesion to a polyolefin material or other low energy substrate and at least a second block that has high affinity (or at least miscibility) with a polar polymeric binder. In a preferred embodiment, it is an object of this invention to provide a block copolymer of ethylene and vinyl acetate, prepared in a controlled manner such that the blocks of ethylene and vinyl acetate are controlled to a desired degree of polymerization or molecular weight.

It is another object of this invention to provide novel block copolymers having the ability to change the surface tension of the olefinic substrate by an amount between about 10 and about 50 mN/m.

In still another object of this invention to provide a block copolymer composed of one ethylene/butene copolymer block and one block of acrylate or vinyl acetate copolymer, prepared in a controlled manner such that the blocks of ethylene/butene and acrylate or vinyl acetate are controlled to a desired degree of polymerization or molecular weight.

It is also an object of this invention to provide a process for free radical polymerization of block copolymers comprising polymeric blocks prepared from olefins (or olefin precursors such as a diene monomer, in the case where the polyolefin is produced after hydrogenation of the polydiene block) and polar monomers, with the polymerization process employing living-type kinetics.

Further aspects and objects of this invention will be evident to those of skill in the art upon review of this specification.

### BRIEF DESCRIPTIONS OF THE FIGURES

FIG. 1 is a bar graph showing the effect of temperature on ethylene incorporation as a function of weight percent ethylene in ethylene-vinyl acetate block copolymers prepared using the methods described herein.

FIG. 2 is a graph showing the effect of temperature on the molecular weight and polydispersity on ethylene-vinyl acetate block copolymers prepared using the methods described herein.

FIG. 3 is a graph showing the weight percent of ethylene incorporated into ethylene-vinyl acetate block copolymers prepared using the methods described herein.

FIG. 4 is a graph showing the effect of the amount of initiator on the molecular weight and polydispersity on ethylene-vinyl acetate block copolymers prepared using the methods described herein.

FIGS. 5A and 5B are representative chromatograms showing the existence of block copolymers prepared in accord with the methods of this invention.

### DETAILED DESCRIPTION OF THE INVENTION

As used herein, “block copolymer” refers to a polymer comprising at least two segments of differing composition; having any one of a number of different architectures, where the monomers are not incorporated into the polymer architecture in a solely statistical or uncontrolled manner. Although there may be three, four or more monomers in block-type polymer architecture, it will still be referred to herein as a block copolymer. In some embodiments, the block copolymer will have an A-B architecture (with “A” and “B” representing the monomers). Other architectures included within the definition of block copolymer include A-B-A, A-B-A-B, A-B-C, A-B-C-A, A-B-C-A-B, A-B-C-B, A-B-A-C (with “C” representing a third monomer), and other combinations that will be obvious to those of skill in the art.

In other embodiments, the block copolymers of this invention include one or more blocks of random copolymer together with one or more blocks of single monomers. Thus, a polymer architecture of A-R, A-R-B, A-B-R, A-R-B-R-C, etc. is included herein, where R is a random block of monomers A and B or of monomers B and C. Moreover, the random block can vary in composition or size with respect to the overall block copolymer. In some embodiments, for example, the random block R will account for between 5 and 80% by weight of the mass of the block copolymer. In other embodiments, the random block R will account for more or less of the mass of the block copolymer, depending on the application. In some embodiments, the random block may have a compositional gradient of one monomer to the other (e.g., A:B) that varies across the random block in an algorithmic fashion, with such algorithm being either linear having a desired slope, exponential having a desired exponent (such as a number from 0.1-5) or logarithmic. The random block may be subject to the same kinetic effects, such as composition drift, that would be present in any other radical copolymerization and its composition, and size may be affected by such kinetics, such as Markov kinetics. Any of the monomers listed elsewhere in this specification may be used in the block copolymers of this invention.

A “block” within the scope of the block copolymers of this invention typically comprises about 10 or more monomers of a single type (with the random blocks being defined by composition and/or weight percent, as described above). In preferred embodiments, the number of monomers within a single block is about 15 or more, about 20 or more or about 50 or more. The blocks in the polymers of this invention may have linking groups between them; for example, such groups may be fragments of (e.g., moieties) a control agent added to the polymerization reaction, such as those control agents discussed herein.

Block copolymers allow the combination of diverse polymer properties into a single material and in this invention, there are at least two types of blocks, one block that has an affinity for a polyolefin material and a second block that has an affinity for polar materials. The first type of block has a high affinity for a polyolefin substrate or polyolefin matrix. In this application, such high affinity means that the olefin compatible block is substantially miscible with polyolefin substrates and is preferably co-crystallizable with the polyolefinic substrate. Melt miscibility can be measured optically and/or with small angle neutron scattering, as is know in the art. Generally, a homopolymers of the olefin block is blended with the olefinic substrate, heated above the highest melting point in the blend and miscibility is checked optically or with small angle neutron scattering. See, generally, Bates et al., Macromolecules, 1997, 30, 3650-3657, which is incorporated herein by reference. Co-crystallization is tested in a similar manner, but with additional steps, including cooling of the melt to permit crystallization and testing with a technique known in the art for crystallization measurement. Melt miscibility may also be assumed where the olefinic block and substrate are made of the same material.

Generally this block is a polyolefin, such as a block of homo-polyethylene (branched, linear or other architecture), polypropylene (with or without isotacticity or syndiotacticity), polybutene, polyhexene, polyoctene, polybutadiene or random copolymers of the same, including ethylene-propylene copolymers, ethylene-butene copolymers, ethylene-hexene copolymers, ethylene-octene copolymers, propylene-butene copolymers, and the like. The olefinic block may also be polyolefins generally known in commercial industry, such as low density polyethylene and other polymers accessible by a free radical polymerization reaction. The olefinic block(s) are prepared from their respective monomers during a polymerization reaction, with such monomers being selected from the group consisting of ethylene, propylene, butene, butadiene, isoprene, dimethylbutadiene etc. Olefinic blocks may be fully or partially hydrogenated in some embodiments.

The at least second block of the copolymers of this invention has a high affinity for polar materials, such as most paints, dyes, polar solvents, etc. This high affinity is based in general on hydrophilic materials being compatible with the polymers found in these coating materials. Thus the second block is generally a poly vinyl acetate, polyvinyalcohol, poly acrylonitrile, poly methacrylate, poly acrylate, poly acrylic acid, or a polymer made from the monomers discussed below, which discussion is included here by reference. It should also be noted that in this application, the term hydrophilic is used as compared to the olefinic block.

In this application, the high affinity towards polyolefinic substrates, matrix or surfaces can also be determined based on the change in surface energy of olefinic substrate before and after treatment with the block copolymers of this invention when a liquid is spotted, painted or otherwise deposited onto the surface or substrate. The surface energy is measured by measuring the contact angle formed using techniques known to those of skill in the art. The contact angle can be measured with optical techniques or with commercially available equipment, such as dyne pens (available from UV Process Supply, Inc., Chicago, Ill.) or the contact angle or surface tension equipment available from First Ten Angstroms, Portsmith, Va. In some embodiments of this invention, the change in surface energy of the polyolefinic surface that results from application of the copolymers discussed herein is in the range of from about 10 millinewtons per meter (mN/m) to about 40 mN/m, more specifically in the range of from about 15 to about 35 mN/m and even more specifically in the range of from about 20 to about 30 mN/m. In other embodiments the surface energy of a polyolefin substrate coated with the block copolymers of this invention will have a surface energy of greater than about 50 mN/m and more specifically greater than about 55 mN/m.

This application also distinguishes from random or “blocky” copolymers of ethylene and vinyl acetate in both the process used to make the polymers of this invention as well as the properties of the resulting polymers. Shimamura et al., Polym. Adv. Technol. 13, 205-209 (2002); Pedemonte et al., Polymer Bulletin, 19, 579-585 (1988); Pedemonte et al., Journ. Calorim., Anal. Therms. Thermodyn. Chim (1986), 17, 192-5; Keating et al., Thermochimica Acta, 284 (1996) 47-56; Cheng et al., Macromolecules, 1988, 21, 3164-3170; Bugada et al., Eur. Polym. J., Vol. 28, No. 3, pp. 219-227, 1992; Brogly et al., J. App/. Polymer Sci., 64 (10): 1903-1912, Jun. 6, 1997; and WO 02/36706. For example, Keating et al., Thermochimica Acta, 243 (1994) 129-145 shows the blocky nature of some polymers (e.g., on page 134) as well as their physical properties, such as a limited vinyl acetate concentration (wt. % of composition) and numerous melting fractions (meaning limited crystallinity with high amounts of vinyl acetate). Similarly, Arsac et al., J. Applied Polymer Science, Vol. 74, pp. 2625-2630 (1999) show that blocky ethylene-vinyl acetate copolymers have crystallinity (which is based on ethylene sequences and their length) disappear with increasing vinyl acetate concentration, with crystallinity effectively gone with a vinyl acetate concentration above about 40% (and possibly above about 28%). This is further supported by Bugada et al. (citation above). It is well known that the presence of microphase separation and various phase morphologies in block copolymers is associated with unique performance attributes of many block copolymers. Thus, the copolymers or coated surfaces or compositions of this invention can be defined by one or more of the distinguishing properties discussed herein. In some embodiments the distinguishing property is the concentration of hydrophilic comonomer content (measured as weight percent), with such concentration being above about 40%, preferably above about 45% and more specifically above about 50%.

The size, composition and/or structure of the blocks in the copolymers of this invention can be adjusted using the polymerization method described below. This allows for an olefinic block having a molecular weight in the range of from about 1,000 to about 150,000, more particularly in the range of from about 1500 to about 80,000 and also in the range of from about 2,000 to about 50,000. The size of the olefinic block should be chosen based on its affinity to the polyolefinic material to which it should adhere for the application of interest. The size of the at least one other, generally hydrophilic block in some embodiments will have a degree of polymerization in the range of from about 1,000 to about 100,000, more particularly in the range of from about 2,000 to about 80,000 and also in the range of from about 3,000 to about 50,000. Different block sizes over all ratios of monomers and molecular weights lead to families of novel compounds, for example thermoplastics, elastomers, adhesives, and polymeric micelles.

More specifically, the ethylene-block-vinyl acetate copolymers of this invention have adhesion properties that are desirable. For example the copolymers of this invention have a 3B or better classification in the cross cut adhesion test (ASTM D-3359), preferably at least a classification of 4B and most preferably a classification of 5B. This test can be described by: scribe parallel lines through coating to substrate, ¼″ apart over a distance of one inch. Scribe another set of parallel lines ¼″ apart and perpendicular to the first set. Apply 3M 4-9239 tape then remove slowly. Results should be lifting of film between scribe lines from 5-15% as classification 3B, less than 5% as classification 4B and no visible lifting of the coating as classification 5B.

The method of preparation of the block copolymers of this invention is one that controls the block size. The process is controlled by use of a control or chain transfer agent (CTA) under polymerization conditions. Polymerization conditions include the temperature of the reaction, ratio of initiator to monomer, ratio of first block to initiator, pressure (including ethylene pressure), as well as other conditions that are well known in the art.

In general, the hydrophilic block is prepared by free radical polymerization of a polar monomer in the presence of a control or chain transfer agent. The agent is incorporated at the polymer chain end by virtue of the polymerization reaction. The agent residue on the block undergoes further reversible transfer reactions when the entity is subjected to free radical polymerization conditions for an olefin monomer (such as those described herein, e.g., ethylene or butadiene) to form the olefinic block with living characteristics and controlled polymer length. This method was found to be more efficient than other methods and also provides the opportunity to control block growth in a commercially acceptable process.

The process can be carried out in solution, bulk and emulsion polymerization. When an olefin monomer is used, due to the limited solubility of the olefin monomer in emulsion media, a solution process may be more practical. Also, proper selection of the solvent can facilitate the recovery of the final polymer. For instance, an optimal solvent is one that solubilizes the hydrophilic block, but is a “non-solvent” for the polyolefinic block and more generally also a “non-solvent” for the entire block copolymer. As an illustration, t-butanol is well suited for the production of block copolymers where the hydrophilic block is polyvinylacetate, polyacrylate or similar compositions, and the olefinic block is polyethylene. In this particular case the final reaction medium is a solvent slurry that can be decanted to isolate the solid polymer and send the solvent to recycling. It is understood however that this example should not limit the scope of the invention.

When an olefin precursor monomer is used instead, such as butadiene, then the preferred process is an emulsion polymerization where the hydrophilic monomer and the CTA is first added to the reaction. After polymerization of the first block, the diene is added, and the reaction is carried out, typically until the diene reaches a targeted conversion beyond which undesirable gel or long chain branching occur, and thereafter the residual diene monomer is vented. Alternatively, the order of monomer addition can be reversed so that the hydrophilic block is grown from the block, the conversion of the monomer is limited to a targeted conversion to avoid unwanted gel and branching material. The residual diene monomer is then stripped off the polymer emulsion. In both cases the polymer is isolated by either coagulation or spray-drying and subsequently reduced to polyolefin blocks materials by known hydrogenation methods

When an olefin monomer is used, the preferred process is split into at least two steps, starting with polymerization of the hydrophilic monomer block to a desired degree of polymerization, which is followed by polymerization of the olefin block. Additional steps can be added, such as purification of the first hydrophilic block (e.g., polyvinylacetate) by isolation or simple removal of residual hydrophilic monomer (e.g., vinyl acetate). For instance, the hydrophilic block (or “living” hydrophilic block) can be chemically modified to provide solubility or dispersibility in water, by hydrolyzing vinyl acetate units in vinyl alcohol, or acrylic ester units into acrylic acids. Also for example, the slurry or solution of the chemically modified olefinic block copolymer can be processed in such a way as to form an emulsion, e.g., by using a phase inversion process where an aqueous solvent is added to the solvent solution/slurry under vigorous agitation until phase inversion occurs; the solvent is then stripped off. Other additional steps will be apparent to those of skill in the art based on this specification.

The first step can be shown schematically in Scheme 1, with vinyl acetate as the hydrophilic monomer with the intention that the monomer chosen for Scheme 1 is non-limiting:

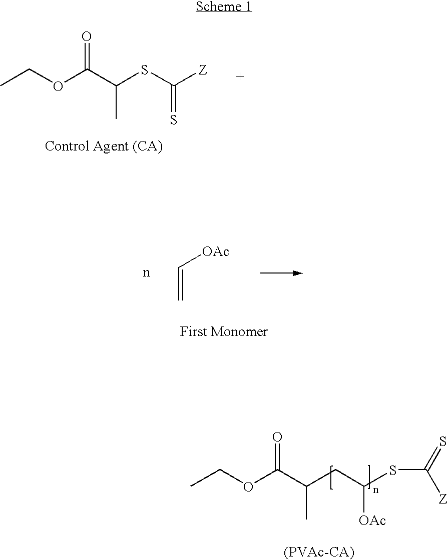

As shown in Scheme 1, a control agent is reacted with the hydrophilic monomer (e.g., vinyl acetate). Z is any group that activates the C═S double bond towards a reversible free radical addition fragmentation reaction. The degree of polymerization is n. The control agent is shown having a particular structure, however such structure is shown only for convenience and is not considered limiting (additional control agents that are useful in this process are discussed in detail below). Scheme 1 does not show certain polymerization condition, such as a preferred temperature and the addition of an initiator (e.g., AIBN). The polymerization conditions are discussed below. The product in the first part of the process is a “living” block of poly hydrophilic monomer (e.g., polyvinylacetate). This is considered a “living” block because additional monomer (the same or different from the monomer used in Scheme 1) can be added to this polymer block and under polymerization conditions, the polymer will add molecular weight, forming a block copolymer if the additional monomer is different. The molecular weight of the block is typically controlled by the molar ratio of monomer to control agent. Generally, the molar ratio of monomer to control agent is in the range of from about 5 to about 5,000, more preferably in the range of from about 10 to about 2,000, and most preferably from 10 to about 1,500.

The second step is the polymerization of at least a second block, an example of which is shown below in Scheme 2.

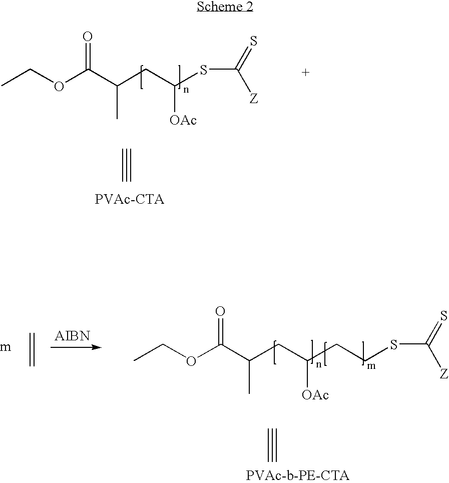

In Scheme 2, the “living” block of polymer that has a high affinity for a polar material is used as a starting material for the polymerization of the olefinic block. The molecular weight of the olefinic block is controlled via adjusting the ratio of the “living” block to initiator, adjusting the pressure of the olefinic monomer fed to the polymerization reaction and adjusting the temperature of the polymerization reaction and/or duration of the polymerization reaction. In general, as the amount of initiator increases, the amount of olefin incorporation into the olefinic block increases. Also generally, the ratio of “living” block to initiator may be in the range of from about 1 to about 1000, more specifically about 2 to about 100 and even more particularly from about 5 to about 50. Also generally, the pressure of the olefinic monomer fed to the polymerization reaction depends on the monomer(s) chosen for the olefinic block. As guidance, for ethylene, the pressure may be in the range of from about 15 psi to about 20,000 psi, more specifically about 150 psi to about 5,000 psi, and even more particularly from about 400 psi to about 1,500 psi. Similarly, the temperature of the polymerization reaction depends on the monomer(s) chosen for the olefinic block. As guidance, for ethylene, the temperature may be in the range of from about 0° C. to about 150° C., more specifically about 25° C. to about 100° C. and even more particularly from about 50° C. to about 80° C.

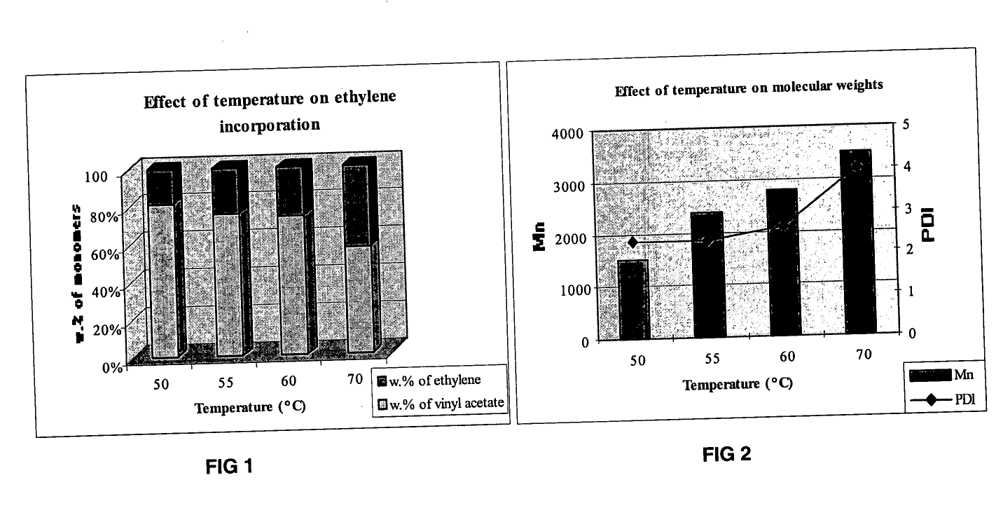

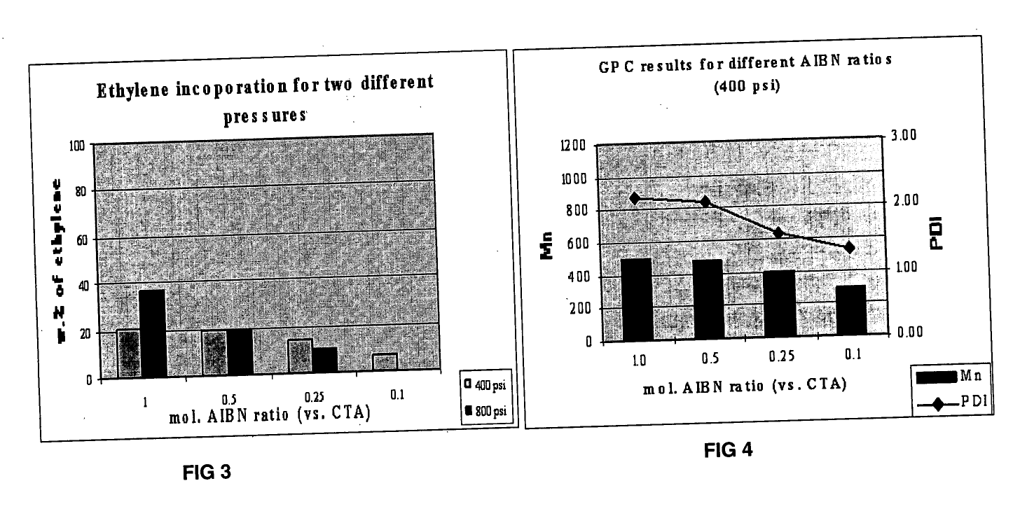

Details of particular conditions are shown in the examples, but those of skill in the art can obtain guidance from FIGS. 1-4. FIG. 1 is a bar graph showing the effect of temperature on ethylene incorporation as a function of weight percent ethylene in ethylene-vinyl acetate block copolymers prepared using the methods described herein. FIG. 1 shows that in general as the temperature is increased, the amount of ethylene incorporated into the block copolymer goes up. FIG. 2 is a graph showing the effect of temperature on the molecular weight and polydispersity on ethylene-vinyl acetate block copolymers prepared using the methods described herein. FIG. 2 shows that in general the number average molecular weight of the polymer goes up as the temperature goes up. FIG. 3 is a graph showing the weight percent of ethylene incorporated into ethylene-vinyl acetate block copolymers prepared using the methods described herein, but at different ethylene pressures and different amounts of initiator added; FIG. 3 supports the generalizations made above. FIG. 4 is a graph showing the effect of the amount of initiator on the molecular weight and polydispersity on ethylene-vinyl acetate block copolymers prepared using the methods described herein; FIG. 4 supports the generalizations made above.

The polymerization conditions that may be used include temperatures for polymerization typically in the range of from about 0° C. to about 150° C., more preferably in the range of from about 25° C. to about 100° C. and even more preferably in the range of from about 50° C. to about 80° C. The atmosphere may be controlled, with an inert atmosphere being preferred, such as nitrogen or argon.

A free radical source is provided in the polymerization mixture, which can stem from spontaneous free radical generation upon heating or preferably from a free radical initiator. In the latter case the initiator is added to the polymerization mixture at a concentration high enough to for an acceptable polymerization rate (e.g., commercially significant conversion in a certain period of time, such as listed below).

Polymerization conditions also include the time for reaction, which may be from about 0.5 hours to about 72 hours, preferably in the range of from about 1 hour to about 24 hours, more preferably in the range of from about 2 hours to about 12 hours. Conversion of monomer to polymer is preferably at least about 50%, more preferably at least about 75% and most preferable at least about 85%.

In those embodiments when an olefin precursor is used, the first step can be shown schematically in Scheme 3, exemplified with ethylacrylate as the hydrophilic monomer and the intention that the monomer chosen for Scheme 3 is non-limiting:

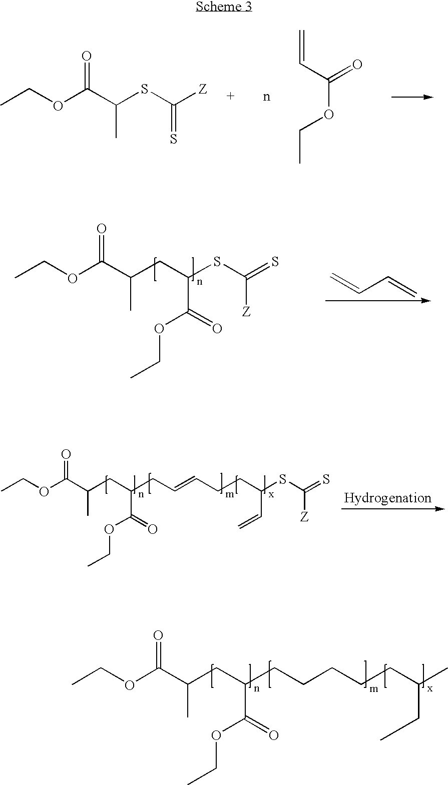

The polymerization process generally proceeds in a “living” type manner. Thus, generally an approximately linear relationship between conversion and number average molecular weight can be observed, although this is not a pre-requisite. The living character manifests itself by the ability to prepare block copolymers: hence, a polymer chain is first grown with monomer A, and then, when monomer A is depleted, monomer B is added to extend the first block of polymer A with a second block of polymer B. Thus, in some instances, particularly when the chain transfer constant of the control agent, Ct, is low (Ct being defined as the ratio of the transfer rate coefficient to the propagation rate constant), e.g., Ct less than 2, the molecular weight to conversion plot might not exhibit a linear trend: this does not preclude however that block copolymer formation did not occur. Block copolymer formation through a living process can be demonstrated using analytical techniques such as polymer fractionation with selective solvent (of block A, block B, respectively), gradient elution chromatography and/or 2-dimensional chromatography. Block copolymers tend to microphase-separate and organize in a variety of morphologies that can be probed by physical techniques such as X-ray diffraction, dynamic mechanical testing, and the like. Gradient elution HPLC has been used, showing the block structure of the polymers of this invention.

Initiators, as discussed above, may be optional. When present, initiators useful in the polymerization mixture and the inventive process are known in the art, and may be selected from the group consisting of alkyl peroxides, substituted alkyl peroxides, aryl peroxides, substituted aryl peroxides, acyl peroxides, alkyl hydroperoxides, substituted alkyl hydroperoxides, aryl hydroperoxides, substituted aryl hydroperoxides, heteroalkyl peroxides, substituted heteroalkyl peroxides, heteroalkyl hydroperoxides, substituted heteroalkyl hydroperoxides, heteroaryl peroxides, substituted heteroaryl peroxides, heteroaryl hydroperoxides, substituted heteroaryl hydroperoxides, alkyl peresters, substituted alkyl peresters, aryl peresters, substituted aryl peresters, and azo compounds. Specific initiators include benzoylperoxide (BPO) and AIBN. The polymerization mixture may use a reaction media is typically either an organic solvent or bulk monomer or neat.

Generally, monomers that may be polymerized using the methods of this invention include at least one monomer is selected from the group consisting of styrene, substituted styrene, alkyl acrylate, substituted alkyl acrylate, alkyl methacrylate, substituted alkyl methacrylate, acrylonitrile, methacrylonitrile, acrylamide, methacrylamide, N-alkylacrylamide, N-alkylmethacrylamide, N,N-dialkylacrylamide, N,N-dialkylmethacrylamide, isoprene, butadiene, ethylene, vinyl acetate and combinations thereof. Functionalized versions of these monomers may also be used. Specific monomers or comonomers that may be used in this invention include methyl methacrylate, ethyl methacrylate, propyl methacrylate (all isomers), butyl methacrylate (all isomers), 2-ethylhexyl methacrylate, isobomyl methacrylate, methacrylic acid, benzyl methacrylate, phenyl methacrylate, methacrylonitrile, α-methylstyrene, methyl acrylate, ethyl acrylate, propyl acrylate (all isomers), butyl acrylate (all isomers), 2-ethylhexyl acrylate, isobornyl acrylate, acrylic acid, benzyl acrylate, phenyl acrylate, acrylonitrile, styrene, glycidyl methacrylate, 2-hydroxyethyl methacrylate, hydroxypropyl methacrylate (all isomers), hydroxybutyl methacrylate (all isomers), N,N-dimethylaminoethyl methacrylate, N,N-diethylaminoethyl methacrylate, triethyleneglycol methacrylate, itaconic anhydride, itaconic acid, glycidyl acrylate, 2-hydroxyethyl acrylate, hydroxypropyl acrylate (all isomers), hydroxybutyl acrylate (all isomers), N,N-dimethylaminoethyl acrylate, N,N-diethylaminoethyl acrylate, triethyleneglycol acrylate, methacrylamide, N-methylacrylamide, N,N-dimethylacrylamide, N-tert-butylmethacrylamide, N-n-butylmethacrylamide, N-methylolmethacrylamide, N-ethylolmethacrylamide, N-tert-butylacrylamide, N-n-butylacrylamide, N-methylolacrylamide, N-ethylolacrylamide, 4-acryloylmorpholine, vinyl benzoic acid (all isomers), diethylaminostyrene (all isomers), α-methylvinyl benzoic acid (all isomers), diethylamino α-methylstyrene (all isomers), p-vinylbenzene sulfonic acid, p-vinylbenzene sulfonic sodium salt, trimethoxysilylpropyl methacrylate, triethoxysilylpropyl methacrylate, tributoxysilylpropyl methacrylate, dimethoxymethylsilylpropyl methacrylate, diethoxymethylsilylpropyl methacrylate, dibutoxymethylsilylpropyl methacrylate, diisopropoxymethylsilylpropyl methacrylate, dimethoxysilylpropyl methacrylate, diethoxysilylpropyl methacrylate, dibutoxysilylpropyl methacrylate, diisopropoxysilylpropyl methacrylate, trimethoxysilylpropyl acrylate, triethoxysilylpropyl acrylate, tributoxysilylpropyl acrylate, dimethoxymethylsilylpropyl acrylate, diethoxymethylsilylpropyl acrylate, dibutoxymethylsilylpropyl acrylate, diisopropoxymethylsilylpropyl acrylate, dimethoxysilylpropyl acrylate, diethoxysilylpropyl acrylate, dibutoxysilylpropyl acrylate, diisopropoxysilylpropyl acrylate, maleic anhydride, N-phenylmaleimide, N-butylmaleimide, butadiene, isoprene, dimethylbutadiene, chloroprene, ethylene, vinyl acetate and combinations thereof

The term hydrophilic monomer as used in this application is a relative term in comparison to olefin monomers (such as ethylene). Thus, any of the above monomers listed above may be considered to be hydrophilic in this application. Those of skill in the art can choose amongst the above-listed monomers to adjust the hydrophilic nature of the block prepared by these monomers, for a variety of reasons, such as adjusting for humidity or weather conditions or for chemical resistance. In some embodiments, suitable hydrophilic monomers may be listed above and include, but are not limited to, acrylic acid, methacrylic acid, N,N-dimethylacrylamide, dimethyl aminoethyl methacrylate, quaternized dimethylaminoethyl methacrylate, methacrylamide, N-t-butyl acrylamide, maleic acid, maleic anhydride and its half esters, crotonic acid, itaconic acid, acrylamide, acrylate alcohols, hydroxyethyl methacrylate, diallyldimethyl ammonium chloride, vinyl ethers (such as methyl vinyl ether), maleimides, vinyl pyridine, vinyl imidazole, other polar vinyl heterocyclics, styrene sulfonate, allyl alcohol methyl methacrylate, vinyl acetate, vinyl acetamide, vinyl alcohol, salts of any acids and amines listed above, and mixtures thereof. Preferred hydrophilic monomers include acrylic acid, ethyl acrylate, vinylalcohol, vinylacetate, N,N-dimethyl acrylamide, dimethylaminoethyl methacrylate, and combinations thereof.

In describing and claiming the present invention, the following terminology will be used in accordance with the definitions set out below. A named R group will generally have the structure that is recognized in the art as corresponding to R groups having that name. For the purposes of illustration, representative R groups as enumerated above are defined herein. These definitions are intended to supplement and illustrate, not preclude, the definitions known to those of skill in the art.

It is also to be understood that the terminology used herein is for the purpose of describing particular embodiments only, and is not intended to be limiting. As used in this specification and the appended claims, the singular forms “a,” “an” and “the” include plural referents unless the context clearly dictates otherwise. In describing and claiming the present invention, the following terminology will be used in accordance with the definitions set out below.

The following definitions pertain to chemical structures, molecular segments and substituents:

As used herein, the phrase “having the structure” is not intended to be limiting and is used in the same way that the term “comprising” is commonly used. The term “independently selected from the group consisting of” is used herein to indicate that the recited elements, e.g., R groups or the like, can be identical or different (e.g., R² and R³ in the structure of formula (1) may all be substituted alkyl groups, or R² may be hydrido and R³ may be methyl, etc.).

“Optional” or “optionally” means that the subsequently described event or circumstance may or may not occur, and that the description includes instances where said event or circumstance occurs and instances where it does not. For example, the phrase “optionally substituted hydrocarbyl” means that a hydrocarbyl moiety may or may not be substituted and that the description includes both unsubstituted hydrocarbyl and hydrocarbyl where there is substitution.

The term “alkyl” as used herein refers to a branched or unbranched saturated hydrocarbon group typically although not necessarily containing 1 to about 24 carbon atoms, such as methyl, ethyl, n-propyl, isopropyl, n-butyl, isobutyl, t-butyl, octyl, decyl, and the like, as well as cycloalkyl groups such as cyclopentyl, cyclohexyl and the like. Generally, although again not necessarily, alkyl groups herein contain 1 to about 12 carbon atoms. The term “lower alkyl” intends an alkyl group of one to six carbon atoms, preferably one to four carbon atoms. “Substituted alkyl” refers to alkyl substituted with one or more substituent groups, and the terms “heteroatom-containing alkyl” and “heteroalkyl” refer to alkyl in which at least one carbon atom is replaced with a heteroatom.

The term “alkenyl” as used herein refers to a branched or unbranched hydrocarbon group typically although not necessarily containing 2 to about 24 carbon atoms and at least one double bond, such as ethenyl, n-propenyl, isopropenyl, n-butenyl, isobutenyl, octenyl, decenyl, and the like. Generally, although again not necessarily, alkenyl groups herein contain 2 to about 12 carbon atoms. The term “lower alkenyl” intends an alkenyl group of two to six carbon atoms, preferably two to four carbon atoms. “Substituted alkenyl” refers to alkenyl substituted with one or more substituent groups, and the terms “heteroatom-containing alkenyl” and “heteroalkenyl” refer to alkenyl in which at least one carbon atom is replaced with a heteroatom.

The term “alkynyl” as used herein refers to a branched or unbranched hydrocarbon group typically although not necessarily containing 2 to about 24 carbon atoms and at least one triple bond, such as ethynyl, n-propynyl, isopropynyl, n-butynyl, isobutynyl, octynyl, decynyl, and the like. Generally, although again not necessarily, alkynyl groups herein contain 2 to about 12 carbon atoms. The term “lower alkynyl” intends an alkynyl group of two to six carbon atoms, preferably three or four carbon atoms. “Substituted alkynyl” refers to alkynyl substituted with one or more substituent groups, and the terms “heteroatom-containing alkynyl” and “heteroalkynyl” refer to alkynyl in which at least one carbon atom is replaced with a heteroatom.

The term “alkoxy” as used herein intends an alkyl group bound through a single, terminal ether linkage; that is, an “alkoxy” group may be represented as —O-alkyl where alkyl is as defined above. A “lower alkoxy” group intends an alkoxy group containing one to six, more preferably one to four, carbon atoms. The term “aryloxy” is used in a similar fashion, with aryl as defined below.

Similarly, the term “alkyl thio” as used herein intends an alkyl group bound through a single, terminal thioether linkage; that is, an “alkyl thio” group may be represented as —S-alkyl where alkyl is as defined above. A “lower alkyl thio” group intends an alkyl thio group containing one to six, more preferably one to four, carbon atoms.

The term “allenyl” is used herein in the conventional sense to refer to a molecular segment having the structure —CH═C═CH₂. An “allenyl” group may be unsubstituted or substituted with one or more non-hydrogen substituents.

The term “aryl” as used herein, and unless otherwise specified, refers to an aromatic substituent containing a single aromatic ring or multiple aromatic rings that are fused together, linked covalently, or linked to a common group such as a methylene or ethylene moiety. The common linking group may also be a carbonyl as in benzophenone, an oxygen atom as in diphenylether, or a nitrogen atom as in diphenylamine. Preferred aryl groups contain one aromatic ring or two fused or linked aromatic rings, e.g., phenyl, naphthyl, biphenyl, diphenylether, diphenylamine, benzophenone, and the like. In particular embodiments, aryl substituents have 1 to about 200 carbon atoms, typically 1 to about 50 carbon atoms, and preferably 1 to about 20 carbon atoms. “Substituted aryl” refers to an aryl moiety substituted with one or more substituent groups, (e.g., tolyl, mesityl and perfluorophenyl) and the terms “heteroatom-containing aryl” and “heteroaryl” refer to aryl in which at least one carbon atom is replaced with a heteroatom.

The term “aralkyl” refers to an alkyl group with an aryl substituent, and the term “aralkylene” refers to an alkylene group with an aryl substituent; the term “alkaryl” refers to an aryl group that has an alkyl substituent, and the term “alkarylene” refers to an arylene group with an alkyl substituent.

The terms “halo” and “halogen” are used in the conventional sense to refer to a chloro, bromo, fluoro or iodo substituent. The terms “haloalkyl,” “haloalkenyl” or “haloalkynyl” (or “halogenated alkyl,” “halogenated alkenyl,” or “halogenated alkynyl”) refers to an alkyl, alkenyl or alkynyl group, respectively, in which at least one of the hydrogen atoms in the group has been replaced with a halogen atom.

The term “heteroatom-containing” as in a “heteroatom-containing hydrocarbyl group” refers to a molecule or molecular fragment in which one or more carbon atoms is replaced with an atom other than carbon, e.g., nitrogen, oxygen, sulfur, phosphorus or silicon. Similarly, the term “heteroalkyl” refers to an alkyl substituent that is heteroatom-containing, the term “heterocyclic” refers to a cyclic substituent that is heteroatom-containing, the term “heteroaryl” refers to an aryl substituent that is heteroatom-containing, and the like. When the term “heteroatom-containing” appears prior to a list of possible heteroatom-containing groups, it is intended that the term apply to every member of that group. That is, the phrase “heteroatom-containing alkyl, alkenyl and alkynyl” is to be interpreted as “heteroatom-containing alkyl, heteroatom-containing alkenyl and heteroatom-containing alkynyl.”

“Hydrocarbyl” refers to univalent hydrocarbyl radicals containing 1 to about 30 carbon atoms, preferably 1 to about 24 carbon atoms, most preferably 1 to about 12 carbon atoms, including branched or unbranched, saturated or unsaturated species, such as alkyl groups, alkenyl groups, aryl groups, and the like. The term “lower hydrocarbyl” intends a hydrocarbyl group of one to six carbon atoms, preferably one to four carbon atoms. “Substituted hydrocarbyl” refers to hydrocarbyl substituted with one or more substituent groups, and the terms “heteroatom-containing hydrocarbyl” and “heterohydrocarbyl” refer to hydrocarbyl in which at least one carbon atom is replaced with a heteroatom.

By “substituted” as in “substituted hydrocarbyl,” “substituted aryl,” “substituted alkyl,” “substituted alkenyl” and the like, as alluded to in some of the aforementioned definitions, is meant that in the hydrocarbyl, hydrocarbylene, alkyl, alkenyl or other moiety, at least one hydrogen atom bound to a carbon atom is replaced with one or more substituents that are functional groups such as hydroxyl, alkoxy, thio, phosphino, amino, halo, silyl, and the like. When the term “substituted” appears prior to a list of possible substituted groups, it is intended that the term apply to every member of that group. That is, the phrase “substituted alkyl, alkenyl and alkynyl” is to be interpreted as “substituted alkyl, substituted alkenyl and substituted alkynyl.” Similarly, “optionally substituted alkyl, alkenyl and alkynyl” is to be interpreted as “optionally substituted alkyl, optionally substituted alkenyl and optionally substituted alkynyl.”

As used herein the term “silyl” refers to the —SiZ¹Z²Z³ radical, where each of Z¹, Z², and Z³ is independently selected from the group consisting of hydrido and optionally substituted alkyl, alkenyl, alkynyl, aryl, aralkyl, alkaryl, heterocyclic, alkoxy, aryloxy and amino.

As used herein, the term “phosphino” refers to the group —PZ¹Z², where each of Z¹ and Z² is independently selected from the group consisting of hydrido and optionally substituted alkyl, alkenyl, alkynyl, aryl, aralkyl, alkaryl, heterocyclic and amino. The term “amino” is used herein to refer to the group —NZ¹Z², where each of Z¹ and Z² is independently selected from the group consisting of hydrido and optionally substituted alkyl, alkenyl, alkynyl, aryl, aralkyl, alkaryl and heterocyclic. The term “thio” is used herein to refer to the group —SZ¹, where Z¹ is selected from the group consisting of hydrido and optionally substituted alkyl, alkenyl, alkynyl, aryl, aralkyl, alkaryl and heterocyclic.

As used herein all reference to the elements and groups of the Periodic Table of the Elements is to the version of the table published by the Handbook of Chemistry and Physics, CRC Press, 1995, which sets forth the new IUPAC system for numbering groups.

Generally, the control or chain transfer agents useful in this invention may be those that function to cause a reversible addition/fragmentation transfer polymerization reaction. These control agents are generally known in the art, including those disclosed in U.S. Pat. Nos. 6,380,335, 6,153,705, WO98/01478, WO99/35177, WO99/31144, and WO98/58974, each of which is incorporated herein by reference. In some embodiments, the control agents useful in this invention may be characterized by the general formula: 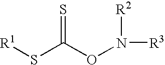
wherein R¹ is generally any group that can be easily expelled under its free radical form (R¹●) upon an addition-fragmentation reaction. More specifically, R¹ is selected from the group consisting of hydrocarbyl, substituted hydrocarbyl, heteroatom-containing hydrocarbyl, and substituted heteroatom-containing hydrocarbyl, and combinations thereof. Even more specifically, R¹ is selected from the group consisting of optionally substituted alkyl, optionally substituted aryl, optionally substituted alkenyl, optionally substituted alkoxy, optionally substituted heterocyclyl, optionally substituted alkylthio, optionally substituted amino and optionally substituted polymer chains. And still more specifically, R¹ is selected from the group consisting of —CH₂Ph, —CH(CH₃)CO₂CH₂CH₃, —CH(CO₂CH₂CH₃)₂, —C(CH₃)₂CN, —CH(Ph)CN and —C(CH₃)₂Ph. Also, R² and R³ are each independently selected from the group consisting of hydrogen, hydrocarbyl, substituted hydrocarbyl, heteroatom-containing hydrocarbyl, and substituted heteroatom-containing hydrocarbyl, and combinations thereof. More specifically, R² and R³ may be each independently selected from the group consisting of hydrogen, optionally substituted alkyl, optionally substituted aryl, optionally substituted alkenyl, optionally substituted acyl, optionally substituted, aroyl, optionally substituted alkoxy, optionally substituted heteroaryl, optionally substituted heterocyclyl, optionally substituted alkylsulfonyl, optionally substituted alkylsulfinyl, optionally substituted alkylphosphonyl, optionally substituted arylsulfinyl, and optionally substituted arylphosphonyl. Specific embodiments of R² and/or R³ are listed in the above definitions, and in addition include perfluorenated aromatic rings, such as perfluorophenyl. Also optionally, R² and R³ can together form a double bond alkenyl moiety off the nitrogen atom, and in that case R² and R³ are together optionally substituted alkenyl moieties. Also optionally, R² and R³ can together form a ring.

In other embodiments, the control agents can be characterized by the general formula: 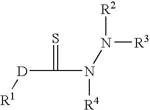
wherein D is S, Te or Se. Preferably, D is sulfur. R¹, R² and R³ are defined above and R⁴ is selected from the group consisting of hydrogen, hydrocarbyl, substituted hydrocarbyl, heteroatom-containing hydrocarbyl, and substituted heteroatom-containing hydrocarbyl, and combinations thereof; and optionally, R⁴ combines with R² and/or R³ to form a ring structure, with said ring having from 3 to 50 non-hydrogen atoms. In particular, R⁴ is selected from the group consisting of hydrogen, optionally substituted alkyl, optionally substituted aryl, optionally substituted alkenyl, optionally substituted acyl, optionally substituted aroyl, amino, thio, optionally substituted aryloxy and optionally substituted alkoxy. Preferred R⁴ groups include methyl and phenyl. Specific control agents useful in this invention include:

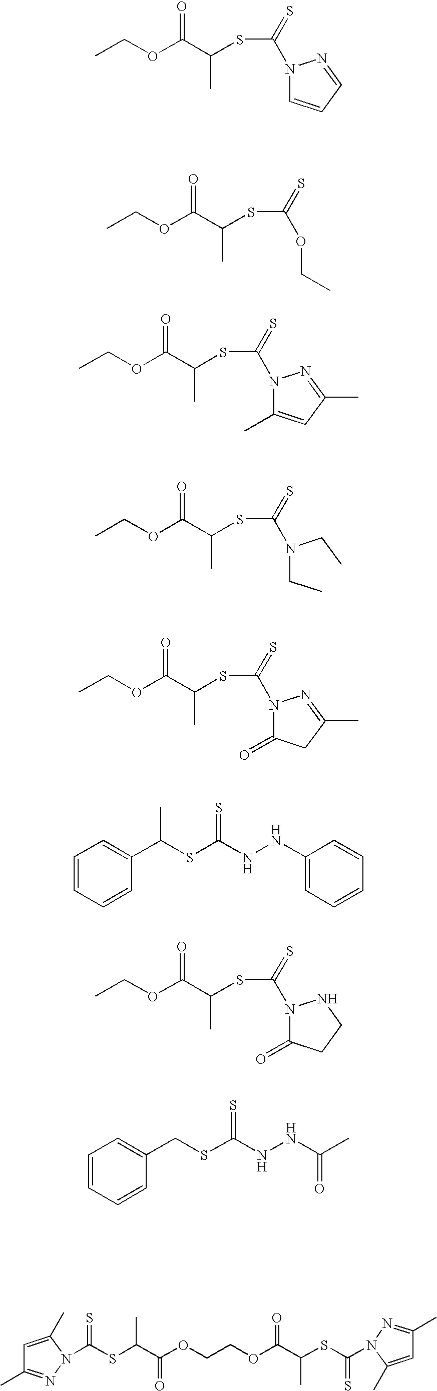

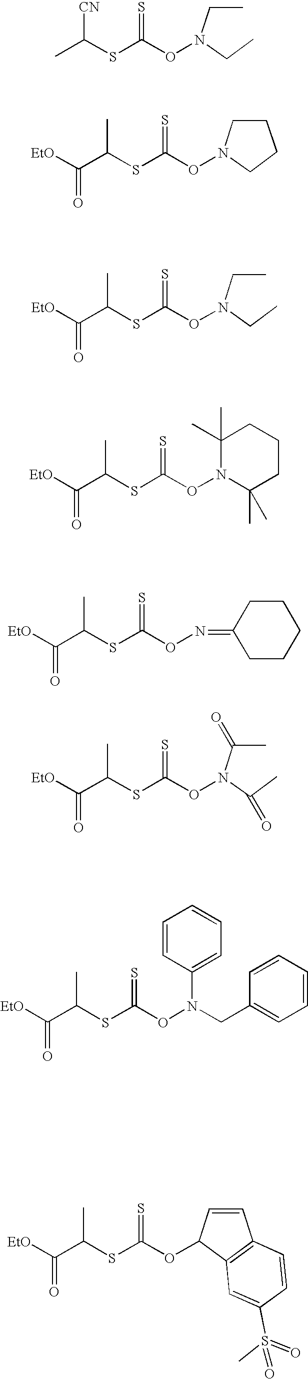

These control agents are prepared by methods described in the above identified patents or other methods known to those of skill in the art, e.g., Castro et al., J. Org. Chem., 1984, 49, 863, which is incorporated herein by reference.

Optionally, after the polymerization is over (e.g., completed or terminated) the thio-moiety (e.g., a dithio-moiety) of the control agent can be cleaved by chemical or thermal ways, if one wants to reduce the sulfur content of the polymer and prevent any problems associated with presence of the control agents chain ends, such as odor or discoloration. Typical chemical treatment includes the catalytic or stoichiometric addition of base such as a primary amine, acid or anhydride, or oxidizing agents such as hypochlorite salts.

### EXAMPLES

General: Vinyl acetate polymerizations were performed in oven-dried glassware under a positive pressure of argon or nitrogen gas while all ethylene polymerizations were performed in the glove box under nitrogen atmosphere and a maximum oxygen level of 3 ppm. All compounds and solvents were degassed under Argon prior to be transferred to the dry-box. AIBN was recrystallized from ether. Fresh stock t-Butanol solutions of PVAc and AIBN were prepared in the dry-box prior to ethylene polymerizations. Elevated Temperature HPLC analysis was performed using an automated system with a C18 column (30 cm) using a Water-THF gradient at a column oven temperature of 60° C., a 50 μL injection size and a flow rate of 0.5 mL/min (ELSD). High Temperature Size Exclusion Chromatography was performed using an automated GPC system equipped with a PL Gel-Mixed B column (300×7.5 mm) and TCB as eluent (150° C. oven, DLSD). Molecular weight and polydispersity index (PDI) are referred to linear polyethylene standards. Syntheses of control agents were carried out under a nitrogen or argon atmosphere. Other chemicals were purchased from commercial sources and used as received, except for monomers, which were filtered through a short column of basic aluminum oxide to remove any inhibitor and degassed by applying vacuum. All polymerization mixtures were prepared in a glove box under a nitrogen or argon atmosphere and sealed, and polymerization was conducted at 50° C., 60° C. or 70° C. Size Exclusion Chromatography was performed using an automated rapid GPC system for the primary screening, available from Polymer Labs (see also WO 99/51980, incorporated herein by reference)

### Example 1

### Polymerization of Vinyl Acetate Block to Create “Living” Polyvinylacetate

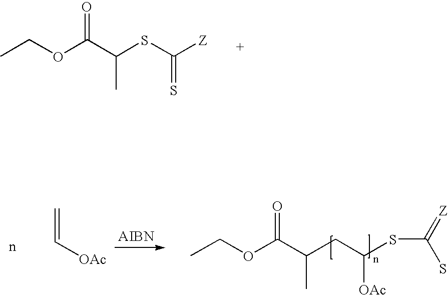

A 500-mL, round-bottomed flask was equipped with a condenser and an inlet adapter for argon or nitrogen gas. It was charged with vinyl acetate (100 g, 1.16 mole), control agent (3.34 mmol) and AIBN (27.4 mg, 0.17 mmol). The control agent was either control agent CTA-1, where z is OCH₂CH₃ or control agent CTA-2, where z is N(CH₂CH₃)₂ and the moles were kept the same with either control agent. The reaction mixture was purged by bubbling an argon-stream for 30 min and then heated at 62° C. for 3 h. After cooling at room temperature (ca. 20° C.), the reaction product was dissolved in 1 L THF, filtered, precipitated with hexanes and dried under vacuum for 24 h to yield 98 g of 24K-PVAc-CTA (target DP=280, i.e., Mn˜24000). Similar procedures were performed to prepare 3K-, 6K-, 12K-PVAc-CTA (target DPs=35, 70, 140, yielding target Mn˜3,000, 6,000, and 12,000 respectively).

### Example 2

### Polymerization of Butyl Acrylate Block to Create “Living” Polybuyl Acrylate

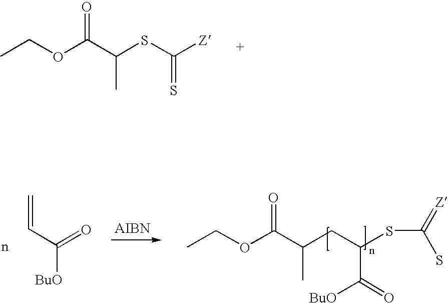

A 500-mL, round-bottomed flask was equipped with a condenser and an inlet adapter for argon or nitrogen gas. It was charged with n-Butyl acrylate (50 g, 0.39 mole), control agent (4.9 mmol) and AIBN (41 mg, 0.25 mmol). The control agent was either control agent CTA-3, where Z′ is 3,5-dimethylpyrazole or control agent CTA-4, where Z′ is 3-methyl-3-pyrazolin-5-one and the moles were kept the same with either control agent. The reaction mixture was purged by bubbling an argon-stream for 30 min and then heated at 65° C. for 6 h. The resulted polymer solution was then allowed to cool down to ambient temperature, and followed by precipitation into methanol/water mixed solvent. The polymers were isolated in 90% yield with CTA-3 (Mn 11500), 80% yield with CTA-4 (Mn 8300).

### Examples 3-146

In each of these examples, the “living” control agent block prepared as discussed in Example 1 was used to form a block copolymer. Certain analytical tests were performed on the block copolymers as described herein. The general procedure for the synthesis of the polyvinylacetate (PVAc)-block-polyethylene (PE) copolymers includes performing the polymerizations in a library format in accord with the following scheme:

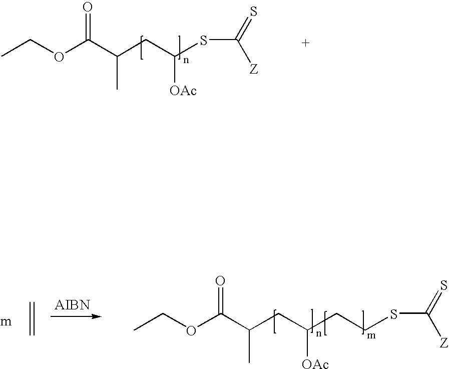

PVAc-b-PE diblock copolymers were synthesized in 8×2 library format in parallel polymerization reactors, which are described in U.S. Pat. No. 6,306,658, which is incorporated herein by reference (available from Symyx Technologies, Inc., Santa Clara, Calif.). Specifically, here, two blocks of eight reactors that are capable of polymerization under pressure were used, based on libraries designed with Library Studio 4.2.1.30 (also available from Symyx Technologies, Inc., Santa Clara, Calif.). The typical procedure for ethylene polymerization on the “living” polyvinyl acetate was as follows: Sixteen glass reaction tubes (one per each well of the pressure reactor) were weighed and transferred to dry-box containing the parallel pressure reactor (which was purged in advance). The tubes were charged with stock solutions of the corresponding polyvinyl acetate (300-600 mg of “living” PVAc in solution) and the respective AIBN solution. Each experiment was taken to a total volume of 4 mL by the addition of t-butanol. The tubes were placed into the reactor wells and the reactor top was placed on the blocks and sealed. Reaction mixtures were stirred using the overhead mechanical stirring at 250 rpm during pressurization with ethylene at the desired pressure. Reaction mixtures were equilibrated for 1 hour and then heated up to 60° C. while stirring speed was increased up to 560 rpm. After 18 h, the ethylene supply and stirring were shut down and the reactor was allowed to cool to ambient temperature (ca. 25° C.). Reactors were slowly depressurized (ca. 4 h). The tops of the reactor blocks were removed and the tubes were taken out. Solvent was removed from the reaction mixtures under centrifugal vacuum using Genevac® evaporator (1 micron at 60° C.) for 12 h. Tubes were weighed and ethylene incorporation was calculated in weight % gain. Polymers solutions (0.1%) were prepared for HT-HPLC (in toluene) and HT-GPC (in TCB). Polymerization conditions as well as ethylene incorporation are reported in Table 1 and 2 respectively.

TABLE 1

| | Control | Initial | Initial Block | Initial Block | AIBN Conc. (wt % | Pressure | Temp. |
|---|---|---|---|---|---|---|---|
| Example | Agent | Block | Mn | Conc. (solids %) | to Initial Block) | (psi) | (° C.) |
| 3 | CTA-1 | PVAc | 535 | 18 | 4 | 800 | 60 |
| 4 | CTA-1 | PVAc | 535 | 24 | 4 | 800 | 60 |
| 5 | CTA-1 | PVAc | 535 | 18 | 4 | 800 | 70 |
| 6 | CTA-1 | PVAc | 535 | 24 | 4 | 800 | 70 |
| 7 | CTA-1 | PVAc | 1466 | 18 | 2 | 800 | 60 |
| 8 | CTA-1 | PVAc | 1466 | 24 | 2 | 800 | 60 |
| 9 | CTA-1 | PVAc | 1466 | 18 | 2 | 800 | 70 |
| 10 | CTA-1 | PVAc | 1466 | 24 | 2 | 800 | 70 |
| 11 | CTA-2 | PVAc | 2130* | 11 | 2 | 800 | 60 |
| 12 | CTA-2 | PVAc | 4110* | 11 | 3.8 | 800 | 60 |
| 13 | CTA-2 | PVAc | 2130* | 6 | 2 | 800 | 60 |
| 14 | CTA-2 | PVAc | 4110* | 6 | 3.8 | 800 | 60 |
| 15 | CTA-2 | PVAc | 2130* | 11 | 1 | 800 | 60 |
| 16 | CTA-2 | PVAc | 4110* | 11 | 2 | 800 | 60 |
| 17 | CTA-2 | PVAc | 2130* | 6 | 1 | 800 | 60 |
| 18 | CTA-2 | PVAc | 4110* | 6 | 2 | 800 | 60 |
| 19 | CTA-2 | PVAc | 136 | 20 | 6.4 | 800 | 60 |
| 20 | CTA-2 | PVAc | 136 | 20 | 3.2 | 800 | 60 |
| 21 | CTA-2 | PVAc | 136 | 20 | 1.6 | 800 | 60 |
| 22 | CTA-2 | PVAc | 136 | 20 | 0.6 | 800 | 60 |
| 23 | CTA-2 | PVAc | 151 | 20 | 5.2 | 800 | 60 |
| 24 | CTA-2 | PVAc | 151 | 20 | 2.6 | 800 | 60 |
| 25 | CTA-2 | PVAc | 151 | 20 | 1.3 | 800 | 60 |
| 26 | CTA-2 | PVAc | 151 | 20 | 0.5 | 800 | 60 |
| 27 | CTA-2 | PVAc | 136 | 30 | 1.7 | 800 | 60 |
| 28 | CTA-2 | PVAc | 136 | 19 | 3.2 | 800 | 60 |
| 29 | CTA-2 | PVAc | 136 | 11 | 6 | 800 | 60 |
| 30 | CTA-2 | PVAc | 136 | 6 | 12.8 | 800 | 60 |
| 31 | CTA-2 | PVAc | 136 | 30 | 0.87 | 800 | 60 |
| 32 | CTA-2 | PVAc | 136 | 19 | 1.6 | 800 | 60 |
| 33 | CTA-2 | PVAc | 136 | 11 | 3 | 800 | 60 |
| 34 | CTA-2 | PVAc | 136 | 6 | 6.4 | 800 | 60 |
| 35 | CTA-2 | PVAc | 136 | 30 | 3.2 | 800 | 60 |
| 36 | CTA-2 | PVAc | 136 | 18 | 3.2 | 800 | 60 |
| 37 | CTA-2 | PVAc | 136 | 11 | 3.2 | 800 | 60 |
| 38 | CTA-2 | PVAc | 136 | 5 | 3.2 | 800 | 60 |
| 39 | CTA-2 | PVAc | 136 | 30 | 1.6 | 800 | 60 |
| 40 | CTA-2 | PVAc | 136 | 18 | 1.6 | 800 | 60 |
| 41 | CTA-2 | PVAc | 136 | 11 | 1.6 | 800 | 60 |
| 42 | CTA-2 | PVAc | 136 | 5 | 1.6 | 800 | 60 |
| 43 | CTA-2 | PVAc | 136 | 18 | 6.4 | 800 | 50 |
| 44 | CTA-2 | PVAc | 136 | 18 | 3.2 | 800 | 50 |
| 45 | CTA-2 | PVAc | 136 | 18 | 1.6 | 800 | 50 |
| 46 | CTA-2 | PVAc | 136 | 18 | 0.6 | 800 | 50 |
| 47 | CTA-2 | PVAc | 136 | 29 | 1.8 | 800 | 50 |
| 48 | CTA-2 | PVAc | 136 | 18 | 3.2 | 800 | 50 |
| 49 | CTA-2 | PVAc | 136 | 10 | 6.5 | 800 | 50 |
| 50 | CTA-2 | PVAc | 136 | 4.7 | 14.4 | 800 | 50 |
| 51 | CTA-2 | PVAc | 136 | 18 | 6.4 | 400 | 60 |
| 52 | CTA-2 | PVAc | 136 | 18 | 3.2 | 400 | 60 |
| 53 | CTA-2 | PVAc | 136 | 18 | 1.6 | 400 | 60 |
| 54 | CTA-2 | PVAc | 136 | 18 | 0.6 | 400 | 60 |
| 55 | CTA-2 | PVAc | 136 | 29 | 1.8 | 400 | 60 |
| 56 | CTA-2 | PVAc | 136 | 18 | 3.2 | 400 | 60 |
| 57 | CTA-2 | PVAc | 136 | 10 | 6.5 | 400 | 60 |
| 58 | CTA-2 | PVAc | 136 | 5 | 14.4 | 400 | 60 |
| 59 | CTA-2 | PVAc | 136 | 17.7 | 6.4 | 800 | 70 |
| 60 | CTA-2 | PVAc | 136 | 17.7 | 3.3 | 800 | 70 |
| 61 | CTA-2 | PVAc | 136 | 17.7 | 1.6 | 800 | 70 |
| 62 | CTA-2 | PVAc | 136 | 17.7 | 0.6 | 800 | 70 |
| 63 | CTA-2 | PVAc | 136 | 30 | 1.6 | 800 | 70 |
| 64 | CTA-2 | PVAc | 136 | 17.7 | 3.3 | 800 | 70 |
| 65 | CTA-2 | PVAc | 136 | 9.7 | 6.6 | 800 | 70 |
| 66 | CTA-2 | PVAc | 136 | 4.1 | 16.6 | 800 | 70 |
| 67 | CTA-2 | PVAc | 136 | 18 | 6.6 | 400 | 60 |
| 68 | CTA-2 | PVAc | 136 | 18 | 3.3 | 400 | 60 |
| 69 | CTA-2 | PVAc | 136 | 18 | 1.6 | 400 | 60 |
| 70 | CTA-2 | PVAc | 136 | 18 | 0.6 | 400 | 60 |
| 71 | CTA-2 | PVAc | 136 | 30 | 1.6 | 400 | 60 |
| 72 | CTA-2 | PVAc | 136 | 18 | 3.3 | 400 | 60 |
| 73 | CTA-2 | PVAc | 136 | 10 | 6.6 | 400 | 60 |
| 74 | CTA-2 | PVAc | 136 | 4 | 16.6 | 400 | 60 |
| 75 | CTA-2 | PVAc | 136 | 17.7 | 6.4 | 800 | 50 |
| 76 | CTA-2 | PVAc | 136 | 17.7 | 3.3 | 800 | 50 |
| 77 | CTA-2 | PVAc | 136 | 17.7 | 1.6 | 800 | 50 |
| 78 | CTA-2 | PVAc | 136 | 17.7 | 0.6 | 800 | 50 |
| 79 | CTA-2 | PVAc | 136 | 30 | 1.6 | 800 | 50 |
| 80 | CTA-2 | PVAc | 136 | 17.7 | 3.3 | 800 | 50 |
| 81 | CTA-2 | PVAc | 136 | 9.7 | 6.6 | 800 | 50 |
| 82 | CTA-2 | PVAc | 136 | 4.1 | 16.6 | 800 | 50 |
| 83 | CTA-2 | PVAc | 1966 | 10 | 0.5 | 800 | 60 |
| 84 | CTA-2 | PVAc | 1966 | 20 | 0.5 | 800 | 60 |
| 85 | CTA-2 | PVAc | 5221 | 10 | 0.5 | 800 | 60 |
| 86 | CTA-2 | PVAc | 5221 | 20 | 0.5 | 800 | 60 |
| 87 | CTA-2 | PVAc | 9016 | 10 | 0.5 | 800 | 60 |
| 88 | CTA-2 | PVAc | 9016 | 20 | 0.5 | 800 | 60 |
| 89 | CTA-2 | PVAc | 14230 | 10 | 0.5 | 800 | 60 |
| 90 | CTA-2 | PVAc | 14230 | 20 | 0.5 | 800 | 60 |
| 91 | CTA-2 | PVAc | 1966 | 10 | 2 | 800 | 60 |
| 92 | CTA-2 | PVAc | 1966 | 20 | 2 | 800 | 60 |
| 93 | CTA-2 | PVAc | 5221 | 10 | 2 | 800 | 60 |
| 94 | CTA-2 | PVAc | 5221 | 20 | 2 | 800 | 60 |
| 95 | CTA-2 | PVAc | 9016 | 10 | 2 | 800 | 60 |
| 96 | CTA-2 | PVAc | 9016 | 20 | 2 | 800 | 60 |
| 97 | CTA-2 | PVAc | 14230 | 10 | 2 | 800 | 60 |
| 98 | CTA-2 | PVAc | 14230 | 20 | 2 | 800 | 60 |
| 99 | CTA-2 | PVAc | 1966 | 10 | 5 | 800 | |
| 100 | CTA-2 | PVAc | 1966 | 20 | 5 | 800 | 60 |
| 101 | CTA-2 | PVAc | 5221 | 10 | 5 | 800 | 60 |
| 102 | CTA-2 | PVAc | 5221 | 20 | 5 | 800 | 60 |
| 103 | CTA-2 | PVAc | 9016 | 10 | 5 | 800 | 60 |
| 104 | CTA-2 | PVAc | 9016 | 20 | 5 | 800 | 60 |
| 105 | CTA-2 | PVAc | 14230 | 10 | 5 | 800 | 60 |
| 106 | CTA-2 | PVAc | 14230 | 20 | 5 | 800 | 60 |
| 107 | CTA-2 | PVAc | 1966 | 10 | 10 | 800 | 60 |
| 108 | CTA-2 | PVAc | 1966 | 20 | 10 | 800 | 60 |
| 109 | CTA-2 | PVAc | 5221 | 10 | 10 | 800 | 60 |
| 110 | CTA-2 | PVAc | 5221 | 20 | 10 | 800 | 60 |
| 111 | CTA-2 | PVAc | 9016 | 10 | 10 | 800 | 60 |
| 112 | CTA-2 | PVAc | 9016 | 20 | 10 | 800 | 60 |
| 113 | CTA-2 | PVAc | 14230 | 10 | 10 | 800 | 60 |
| 114 | CTA-2 | PVAc | 14230 | 20 | 10 | 800 | 60 |
| 115 | CTA-2 | PVAc | 1966 | 10 | 20 | 800 | 60 |
| 116 | CTA-2 | PVAc | 1966 | 20 | 20 | 800 | 60 |
| 117 | CTA-2 | PVAc | 5221 | 10 | 20 | 800 | 60 |
| 118 | CTA-2 | PVAc | 5221 | 20 | 20 | 800 | 60 |
| 119 | CTA-2 | PVAc | 9016 | 10 | 20 | 800 | 60 |
| 120 | CTA-2 | PVAc | 9016 | 20 | 20 | 800 | 60 |
| 121 | CTA-2 | PVAc | 14230 | 10 | 20 | 800 | 60 |
| 122 | CTA-2 | PVAc | 14230 | 20 | 20 | 800 | 60 |
| 123 | CTA-2 | PVAc | 1966 | 10 | 0.5 | 1100 | 60 |
| 124 | CTA-2 | PVAc | 1966 | 20 | 0.5 | 1100 | 60 |
| 125 | CTA-2 | PVAc | 5221 | 10 | 0.5 | 1100 | 60 |
| 126 | CTA-2 | PVAc | 5221 | 20 | 0.5 | 1100 | 60 |
| 127 | CTA-2 | PVAc | 9016 | 10 | 0.5 | 1100 | 60 |
| 128 | CTA-2 | PVAc | 9016 | 20 | 0.5 | 1100 | 60 |
| 129 | CTA-2 | PVAc | 14230 | 10 | 0.5 | 1100 | 60 |
| 130 | CTA-2 | PVAc | 14230 | 20 | 0.5 | 1100 | 60 |
| 131 | CTA-2 | PVAc | 1966 | 10 | 2 | 1100 | 60 |
| 132 | CTA-2 | PVAc | 1966 | 20 | 2 | 1100 | 60 |
| 133 | CTA-2 | PVAc | 5221 | 10 | 2 | 1100 | 60 |
| 134 | CTA-2 | PVAc | 5221 | 20 | 2 | 1100 | 60 |
| 135 | CTA-2 | PVAc | 9016 | 10 | 2 | 1100 | 60 |
| 136 | CTA-2 | PVAc | 9016 | 20 | 2 | 1100 | 60 |
| 137 | CTA-2 | PVAc | 14230 | 10 | 2 | 1100 | 60 |
| 138 | CTA-2 | PVAc | 14230 | 20 | 2 | 1100 | 60 |
| 139 | CTA-2 | PVAc | 1966 | 10 | 5 | 1100 | 60 |
| 140 | CTA-2 | PVAc | 1966 | 20 | 5 | 1100 | 60 |
| 141 | CTA-2 | PVAc | 5221 | 10 | 5 | 1100 | 60 |
| 142 | CTA-2 | PVAc | 5221 | 20 | 5 | 1100 | 60 |
| 143 | CTA-2 | PVAc | 9016 | 10 | 5 | 1100 | 60 |
| 144 | CTA-2 | PVAc | 9016 | 20 | 5 | 1100 | 60 |
| 145 | CTA-2 | PVAc | 14230 | 10 | 5 | 1100 | 60 |
| 146 | CTA-2 | PVAc | 14230 | 20 | 5 | 1100 | 60 |
| 147 | CTA-4 | PBA | 8300 | 9 | 10 | 800 | 65 |
| 148 | CTA-4 | PBA | 8300 | 16 | 10 | 800 | 65 |
| 149 | CTA-3 | PBA | 11500 | 9 | 10 | 800 | 65 |
| 150 | CTA-3 | PBA | 11500 | 16 | 10 | 800 | 65 |
| 151 | CTA-4 | PBA | 8300 | 16 | 10 | 800 | 65 |
| 152 | CTA-3 | PBA | 11500 | 16 | 5 | 800 | 65 |
| 153 | CTA-3 | PBA | 11500 | 16 | 7.5 | 800 | 65 |
| 154 | CTA-3 | PBA | 11500 | 16 | 10 | 800 | 65 |

TABLE 2
Results

| | Initial PVAc | Initial | Final block | Final block | Weight % | Final first block | Final Ethylene |
|---|---|---|---|---|---|---|---|
| Example | Mn | PVAc PDI | copolymer Mn | copolymer PDI | Gain | Weight % | Weight % |
| 3 | 535 | 1.48 | 1491 | 2.28 | 33 | 75 | 25 |
| 4 | 535 | 1.48 | 1311 | 2.42 | 30 | 77 | 23 |
| 5 | 535 | 1.48 | 1848 | 4.84 | 96 | 51 | 49 |
| 6 | 535 | 1.48 | 1847 | 4.95 | 84 | 54 | 46 |
| 7 | 1466 | 1.57 | 3045 | 2.26 | 20 | 83 | 17 |
| 8 | 1466 | 1.57 | 2678 | 2.3 | 19 | 84 | 16 |
| 9 | 1466 | 1.57 | 3616 | 4.01 | 74 | 57 | 43 |
| 10 | 1466 | 1.57 | 3313 | 4.22 | 63 | 61 | 39 |
| 11 | 2130* | 1.51* | 1522 | 2.46 | 5 | 95 | 5 |
| 12 | 4110* | 1.59* | 1341 | 2.71 | 24 | 81 | 19 |
| 13 | 2130* | 1.51* | 1208 | 2.42 | 1 | 99 | 1 |
| 14 | 4110* | 1.59* | 1199 | 3.5 | 26 | 79 | 21 |
| 15 | 2130* | 1.51* | 3311 | 3.22 | 45 | 69 | 31 |
| 16 | 4110* | 1.59* | 2079 | 3.14 | 56 | 64 | 36 |
| 17 | 2130* | 1.51* | 3734 | 3.85 | 65 | 61 | 39 |
| 18 | 4110* | 1.59* | 2796 | 3.32 | 84 | 54 | 46 |
| 19 | 136 | 2 | 939 | 4.1 | 57 | 64 | 36 |
| 20 | 136 | 2 | 628 | 3.4 | 30 | 77 | 23 |
| 21 | 136 | 2 | 377 | 2.62 | 9 | 92 | 8 |
| 22 | 136 | 2 | 214 | 1.52 | — | | |
| 23 | 151 | 2.97 | 1216 | 3.57 | 64 | 61 | 39 |
| 24 | 151 | 2.97 | 726 | 5.92 | 40 | 71 | 29 |
| 25 | 151 | 2.97 | 791 | 2.81 | 22 | 82 | 18 |
| 26 | 151 | 2.97 | 654 | 2.62 | 16 | 86 | 14 |
| 27 | 136 | 2 | 732 | 2.95 | 30 | 77 | 23 |
| 28 | 136 | 2 | 887 | 3.92 | 50 | 67 | 33 |
| 29 | 136 | 2 | 1476 | 5.19 | 87 | 53 | 47 |
| 30 | 136 | 2 | 2713 | 5.59 | 181 | 36 | 64 |
| 31 | 136 | 2 | 391 | 2.53 | 13 | 88 | 12 |
| 32 | 136 | 2 | 565 | 3.6 | 23 | 81 | 19 |
| 33 | 136 | 2 | 920 | 4.49 | 54 | 65 | 35 |
| 34 | 136 | 2 | 1195 | 3.74 | 72 | 58 | 42 |
| 35 | 136 | 2 | 127 | 6.82 | 39 | 72 | 28 |
| 36 | 136 | 2 | 204 | 14.7 | 50 | 67 | 33 |
| 37 | 136 | 2 | 225 | 13 | 47 | 68 | 32 |
| 38 | 136 | 2 | 1191 | 4.28 | 71 | 58 | 42 |
| 39 | 136 | 2 | 114 | 5.42 | 10 | 91 | 9 |
| 40 | 136 | 2 | 356 | 6.47 | 13 | 88 | 12 |
| 41 | 136 | 2 | 28 | 6.64 | 4 | 96 | 4 |
| 42 | 136 | 2 | 67 | 3.4 | — | | |
| 43 | 136 | 2 | 296 | 5.9 | 30 | 77 | 23 |
| 44 | 136 | 2 | 299 | 4.84 | 19 | 84 | 16 |
| 45 | 136 | 2 | 198 | 4.24 | — | | |
| 46 | 136 | 2 | 109 | 4.76 | 15 | 87 | 13 |
| 47 | 136 | 2 | 103 | 3.33 | 2 | 98 | 2 |
| 48 | 136 | 2 | 137 | 4.99 | 20 | 83 | 17 |
| 49 | 136 | 2 | 229 | 8.31 | 27 | 79 | 21 |
| 50 | 136 | 2 | 283 | 10.5 | 51 | 66 | 34 |
| 51 | 136 | 2 | 499 | 2.18 | 30 | 77 | 23 |
| 52 | 136 | 2 | 478 | 2.1 | 23 | 81 | 19 |
| 53 | 136 | 2 | 392 | 1.59 | 13 | 88 | 12 |
| 54 | 136 | 2 | 293 | 1.33 | 5.6 | 95 | 5 |
| 55 | 136 | 2 | 418 | 1.64 | 14 | 88 | 12 |
| 56 | 136 | 2 | 630 | 1.77 | 30 | 77 | 23 |
| 57 | 136 | 2 | 636 | 1.94 | 26 | 79 | 21 |
| 58 | 136 | 2 | 1171 | 2.79 | 55 | 65 | 35 |
| 59 | 136 | 2 | 1946 | 3.7 | 114 | 47 | 53 |
| 60 | 136 | 2 | 1863 | 3.48 | 72 | 58 | 42 |
| 61 | 136 | 2 | 1301 | 3.59 | 44 | 69 | 31 |
| 62 | 136 | 2 | 409 | 3.08 | 9 | 92 | 8 |
| 63 | 136 | 2 | 1026 | 2.99 | 46 | 68 | 32 |
| 64 | 136 | 2 | 2078 | 2.97 | 93 | 52 | 48 |
| 65 | 136 | 2 | 2582 | 3.48 | 176 | 36 | 64 |
| 66 | 136 | 2 | 4394 | 2.71 | 433 | 19 | 81 |
| 67 | 136 | 2 | 278 | 4.95 | 18 | 85 | 15 |
| 68 | 136 | 2 | 202 | 5.21 | 15 | 87 | 13 |
| 69 | 136 | 2 | 198 | 4.22 | 12 | 89 | 11 |
| 70 | 136 | 2 | 147 | 3.56 | 9 | 92 | 8 |
| 71 | 136 | 2 | 117 | 5.14 | 7 | 93 | 7 |
| 72 | 136 | 2 | 244 | 4.77 | 7 | 93 | 7 |
| 73 | 136 | 2 | 308 | 7.63 | 25 | 80 | 20 |
| 74 | 136 | 2 | 522 | 8.28 | 77 | 56 | 44 |
| 75 | 136 | 2 | 297 | 10.5 | 27 | 79 | 21 |
| 76 | 136 | 2 | 233 | 8.8 | 13 | 88 | 12 |
| 77 | 136 | 2 | 130 | 5.76 | 3 | 97 | 3 |
| 78 | 136 | 2 | 80 | 2.73 | — | | |
| 79 | 136 | 2 | 179 | 5.29 | 5 | 95 | 5 |
| 80 | 136 | 2 | 239 | 9.85 | 21 | 83 | 17 |
| 81 | 136 | 2 | 1901 | 3.09 | 47 | 68 | 32 |
| 82 | 136 | 2 | 3947 | 3.36 | 112 | 47 | 53 |
| 83 | 1966 | 1.59 | 3725 | 1.5 | 46 | 68 | 32 |
| 84 | 1966 | 1.59 | 3154 | 1.32 | 55 | 65 | 35 |
| 85 | 5221 | 1.54 | 7812 | 1.64 | 71 | 58 | 42 |
| 86 | 5221 | 1.54 | 6935 | 1.36 | 38 | 72 | 28 |
| 87 | 9016 | 1.6 | 10630 | 1.67 | — | | |
| 88 | 9016 | 1.6 | 11290 | 1.53 | 23 | 81 | 19 |
| 89 | 14230 | 1.53 | 14180 | 1.87 | — | | |
| 90 | 14230 | 1.53 | 12990 | 1.54 | 26 | 79 | 21 |
| 91 | 1966 | 1.59 | 5909 | 1.81 | 85 | 54 | 46 |
| 92 | 1966 | 1.59 | 5464 | 1.73 | 51 | 66 | 34 |
| 93 | 5221 | 1.54 | 16560 | 2.11 | 93 | 52 | 48 |
| 94 | 5221 | 1.54 | 11530 | 1.99 | 48 | 68 | 32 |
| 95 | 9016 | 1.6 | 18240 | 2.27 | 70 | 59 | 41 |
| 96 | 9016 | 1.6 | 15490 | 2.3 | 49 | 67 | 33 |
| 97 | 14230 | 1.53 | 25070 | 2.6 | 89 | 53 | 47 |
| 98 | 14230 | 1.53 | 17240 | 2.5 | 54 | 65 | 35 |
| 99 | 1966 | 1.59 | 10240 | 1.54 | 130 | 43 | 57 |
| 100 | 1966 | 1.59 | 6330 | 1.69 | 77 | 56 | 44 |
| 101 | 5221 | 1.54 | 17510 | 1.93 | 61 | 62 | 38 |
| 102 | 5221 | 1.54 | 11870 | 2.13 | 89 | 53 | 47 |
| 103 | 9016 | 1.6 | 21630 | 2.35 | 105 | 49 | 51 |
| 104 | 9016 | 1.6 | 16540 | 2.29 | 77 | 56 | 44 |
| 105 | 14230 | 1.53 | 31880 | 2.91 | 114 | 47 | 53 |
| 106 | 14230 | 1.53 | 28470 | 2.91 | 80 | 56 | 44 |
| 107 | 1966 | 1.59 | 15090 | 1.9 | 403 | 20 | 80 |
| 108 | 1966 | 1.59 | 12150 | 1.87 | 266 | 27 | 73 |
| 109 | 5221 | 1.54 | 19010 | 1.97 | 402 | 20 | 80 |
| 110 | 5221 | 1.54 | 16250 | 2.08 | 254 | 28 | 72 |
| 111 | 9016 | 1.6 | 28500 | 1.74 | 379 | 21 | 79 |
| 112 | 9016 | 1.6 | 18410 | 2.4 | 239 | 29 | 71 |
| 113 | 14230 | 1.53 | 20940 | 2.61 | 349 | 22 | 78 |
| 114 | 14230 | 1.53 | 19990 | 2.84 | 245 | 29 | 71 |
| 115 | 1966 | 1.59 | 14440 | 2.19 | 517 | 16 | 84 |
| 116 | 1966 | 1.59 | 10600 | 1.85 | 312 | 24 | 76 |
| 117 | 5221 | 1.54 | 16120 | 2.06 | 490 | 17 | 83 |
| 118 | 5221 | 1.54 | 14920 | 2.29 | 267 | 27 | 73 |
| 119 | 9016 | 1.6 | 18800 | 2.43 | 412 | 20 | 80 |
| 120 | 9016 | 1.6 | 12190 | 2.67 | 303 | 25 | 75 |
| 121 | 14230 | 1.53 | 13860 | 2.22 | 526 | 16 | 84 |
| 122 | 14230 | 1.53 | 11870 | 2.68 | 243 | 29 | 71 |
| 123 | 1966 | 1.59 | 3164 | 1.95 | 17 | 85 | 15 |
| 124 | 1966 | 1.59 | 3145 | 1.51 | 18 | 85 | 15 |
| 125 | 5221 | 1.54 | 7349 | 1.57 | 23 | 81 | 19 |
| 126 | 5221 | 1.54 | 6649 | 1.49 | 19 | 84 | 16 |
| 127 | 9016 | 1.6 | 10650 | 1.47 | 19 | 84 | 16 |
| 128 | 9016 | 1.6 | 12270 | 1.56 | 19 | 84 | 16 |
| 129 | 14230 | 1.53 | 14140 | 1.51 | 14 | 88 | 12 |
| 130 | 14230 | 1.53 | 21680 | 1.51 | 19 | 84 | 16 |
| 131 | 1966 | 1.59 | 3206 | 1.41 | 70 | 59 | 41 |
| 132 | 1966 | 1.59 | 4061 | 1.66 | 57 | 64 | 36 |
| 133 | 5221 | 1.54 | 9548 | 2.08 | 68 | 60 | 40 |
| 134 | 5221 | 1.54 | 11270 | 1.72 | 63 | 61 | 39 |
| 135 | 9016 | 1.6 | 15400 | 1.93 | 68 | 60 | 40 |
| 136 | 9016 | 1.6 | 12870 | 1.62 | 70 | 59 | 41 |
| 137 | 14230 | 1.53 | 16020 | 1.56 | 53 | 65 | 35 |
| 138 | 14230 | 1.53 | 18610 | 1.68 | 73 | 58 | 42 |
| 139 | 1966 | 1.59 | 4415 | 2.15 | 101 | 50 | 50 |
| 140 | 1966 | 1.59 | 6271 | 1.49 | 89 | 53 | 47 |
| 141 | 5221 | 1.54 | 15370 | 1.74 | 113 | 47 | 53 |
| 142 | 5221 | 1.54 | 8135 | 1.77 | 96 | 51 | 49 |
| 143 | 9016 | 1.6 | 14620 | 1.88 | 94 | 52 | 48 |
| 144 | 9016 | 1.6 | 13840 | 1.69 | 97 | 51 | 49 |
| 145 | 14230 | 1.53 | 15420 | 1.71 | 94 | 52 | 48 |
| 146 | 14230 | 1.53 | 22260 | 1.59 | 109 | 48 | 52 |
| 147 | 2700 | 1.3 | 4100 | 1.3 | 194 | 34 | 66 |
| 148 | 2700 | 1.3 | 4200 | 1.3 | 156 | 39 | 61 |
| 149 | 6100 | 1.3 | 4900 | 1.5 | 175 | 36 | 64 |
| 150 | 6100 | 1.3 | 6100 | 1.6 | 125 | 44 | 56 |
| 151 | 2700 | 1.3 | 3200 | 1.5 | 38 | 73 | 27 |
| 152 | 6100 | 1.3 | 7400 | 1.4 | 13 | 89 | 11 |
| 153 | 6100 | 1.3 | 6100 | 1.5 | 50 | 67 | 33 |
| 154 | 6100 | 1.3 | 5600 | 1.6 | 75 | 57 | 43 |

*refers to data obtained from conventional GPC system in THF with polystyrene calibration.

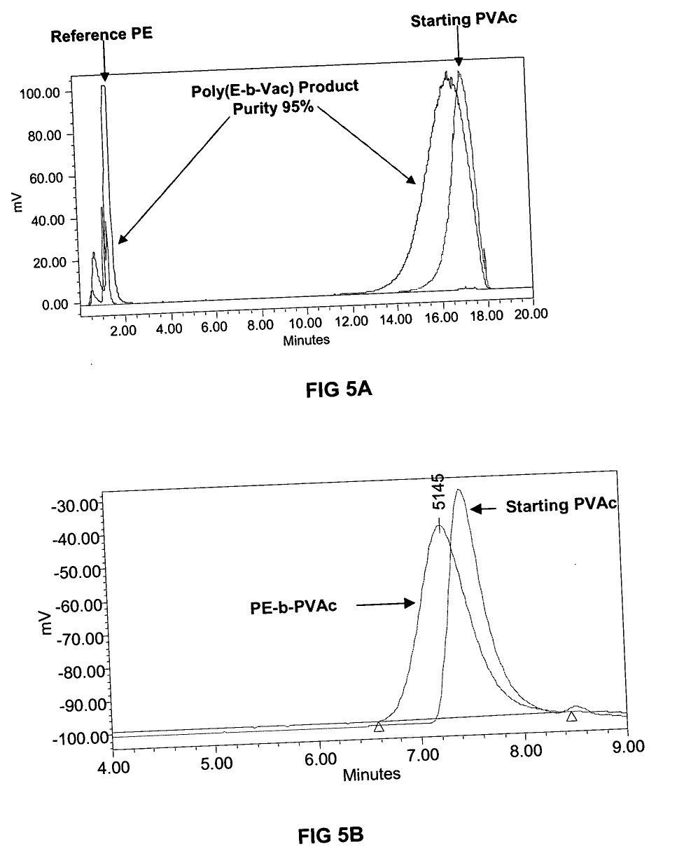

In connection with these examples, representative chromatograms are presented in FIG. 5A, which is an HPLC chromatogram from the polymer of Example 7, showing the existence of the block copolymer and FIG. 5B, which is a high temperature GPC chromatogram from the polymer of Example 7 that also shows the existence of the block copolymer.

### Examples 155-173

### Emulsion Synthesis of Polystyrene-b-(polybutadiene-co-polystyrene) and their Hydrogenation

Emulsion Polymerization:

P(S-b-(BD-co-S)) block copolymers were synthesized in emulsion in an 18 element array, where the first 16 elements were diblocks and the last two elements were stopped after only the first block of PS was synthesized. Specifically, a reactor capable of polymerizations under pressure, and capable of semi-continuous control of chemical reagents, was used, as disclosed in WO 01/93998, which is incorporated herein by reference. Briefly, the parallel reactor is suitably configured for operation in semi-continuous or continuous mode comprising reaction vessels for containing liquid reaction mixtures. Each of the vessels is pressurizable and integral with (e.g. formed or otherwise contained in) a common reactor block. Shaft-driven stirrers (e.g., shaft-driven impellers) are provided for stirring the reaction mixtures arranged to correspond to the arrangement of the reaction vessels. The reactor vessels also have at least four feed lines (e.g., liquid feed lines) in fluid communication with the reaction vessels for providing one or more reagent sources (e.g. liquid reagent sources). The system also includes a feed-pressurization station (e.g., pressurized waste vessel), one or more modular feed-line subassemblies (e.g. ferrules), capillary-type feed lines, multi-section (e.g., two-section) feed lines, multiple feed lines with independently and differently-positioned distal ends, feed lines with independently and differently-varied feed-line sizes, disposable shaft-covers and/or disposable header block gaskets for masking at least non-disposable portions of the shafts or header that are exposed within the reaction cavity and/or specific feed distribution system designs, including especially feed distribution systems in which one or more source vessels are multiplexed through a single pump (e.g., syringe pump) and one or more selection valves (e.g., feed distribution valves), to each of multiple feed lines serving multiple reaction vessels.

In general, the feed lines are capillary feed lines (e.g., glass (e.g., fused silica) capillaries, stainless-steel capillaries and/or polymer (e.g. teflon) capillaries) that have a distal end positioned within the reaction vessel, and the distal end the feed lines (i.e., a first subset of the feed lines) is positioned lower in the reaction vessel relative to the distal end of one or more other of the feed lines (i.e., a second subset of the feed lines). The reactor is used to effect multi-feed chemical reactions in parallel—generally by feeding liquid reagents through the feed lines to each of the reactors during the course of a reaction. Additionally, and generally, such methods are preferably implemented with user-directed reactor-control software or firmware incorporated with the reactor, together with a graphical user interface. The feed control, for each of the reaction vessels, includes controlling (e.g., specifying and/or directing) (i) a total volume of each of the liquid reagents being fed to the reaction vessel during the reaction, the total volume being the same or different as compared between different reagents, (ii) a number of stages in which the total volume for each of the liquid reagents are fed to the reaction vessel during the reaction, the number of stages being the same or different as compared between different reagents, (iii) a stage volume defined by a percentage of the total volume associated with each of the stages for each of the liquid reagents, the stage volume being the same or different as compared between different stages for each of the liquid reagents, (iv) a feed sequence defined by a relative order in which the stages for each of the liquid reagents are fed to the reaction vessel during the reaction, and (v) a temporal profile associated with feed addition to the reaction vessel for each of the stages for each of the liquid reagents, the temporal profile being defined for each stage by a number of feed increments in which the stage volume is added to the reaction vessel, and the period of time in which the stage volume is added to the reaction vessel.

The typical procedure used for forming these diblocks in emulsion is as follows: In a glove box stock solutions of potassium persulfate (KPS), t-butylhydroperoxide (tBHP), and sodium formaldehyde sulfoxylate (SFS) were prepared in water in glass vials sealed with septa. Similarly a solution of phenothiazine and diethylhydroxyl amine in styrene was prepared as the short-stop solution. Also, pure water and pure styrene were placed in glass vials sealed with septa. Lastly, the CTA reagent (CTA-3, Z=2,5-dimethyl pyrazole) was dissolved in styrene and added to a preformed emulsion in order to load the CTA into the starting seed latex. All of these sealed containers were removed from the glovebox, attached to independent feed lines on the semi-continuous reactor, and those lines were primed with the solutions. Into a pressure vessel attached to the reactor, butadiene was condensed. Next, 16 glass vials were inserted into the reactor positions of the semi-continuous pressure reactor. The reactor was equipped with stir shafts, sealed, and then purged with nitrogen. The butadiene pressure vessel, the reactors, and the waste vessel were then pressurized to 120 psig with nitrogen, and the butadiene lines were primed. At this point the recipe (shown in Table 3) was loaded into the computer and the semi-continuous process was started. The initial charge consisted of all of the CTA-loaded-seed, KPS solution, and pure water, and 10% of the styrene that was to be used in the pure styrene block. Once the initial charge was loaded to each vessel the stirring was started at 400 rpm, and the reactors were all brought to 60° C. Next the remainder of the styrene that was to be used in the pure styrene block was added in a linear fashion in 100 intervals over the next two hours, while the temperature was held at 60° C. for four hours (two hours past the styrene feed). At this point the reactor temperature was dropped to 40° C. for the first 8 vessels, 50° C. for the second 8 vessels, and allowed to cool to room temperature for the last two vessels. Subsequently to the first 16 vessels was added all of the butadiene, tBHP solution, and the styrene that was to be used in the butadiene soft block. Once this charge was into the reactors, the SFS solution was added in a linear fashion in 100 intervals over the next two hours, while the temperature was held at 40° C. or 50° C. for four hours (two hours past the SFS feed). At the end of this time, the short-stop solution was added to each reactor, and the reactors were allowed to cool to room temperature with stirring. Once at ambient temperature, the pressure was slowly released from the reactors over approximately four hours, the reactors were opened, and the glass vials containing the emulsions were removed.

A similar procedure for emulsion synthesis of Polyethyl acrylate-b-polybutadiene as following: An array of P(Ea-b-BD) samples were prepared in emulsion a similar fashion to the synthesis of the P(S-b-BD) block copolymers described in Example 1. In this case the CTA (CTA-3) was dissolved in ethyl acrylate and added to the preformed emulsion in order to load the CTA into the starting seed latex. This emulsion was then loaded into the semicontinuous reactor along with persulfate and additional water and heated 60° C. Subsequently, additional Ea was added slowly over the next two hours while temperature was maintained at 60° C. for 4 hours. The temperature was then reduced 40° C. and the butadiene and tBHP were added, followed by the slow addition of SFS over 2 hours with the temperature being maintained at 40° C. for 4 hours. At the end of this time the short-stop solution was added and the reactions were allowed to cool to room temperature before depressurization and removal of the emulsions from the reactor.

Polymerization conditions and results are reported in Tables 3 and 4 respectively.

Hydrogenation of Polystyrene-b-(polybutadiene-co-polystyrene)

Hydrogenation was performed in an 24 element array reflux reactor equipped with 24 parallel reflux condensers and magnetic stirs, temperature control, and an inert atmosphere (Ar). Emulsions in 400 uL each from Example 155-170 were transferred to the reactor's glass tubes, respectively, and then followed by freeze-drying. To these freeze-dried materials were added 1 ml of xylene and 800 mg of p-toluene sulfondydrazide. The mixtures were then purged with Argon for 5 minutes at ambient temperature, and then were heated to 125° C. for 8 hours. After the reaction mixtures cooled down to ambient temperature, methanol (10 mL) was added to each reaction tube, and followed by a vigorous agitation for 10 minutes. The resulted suspensions were then filtered. The filtered solids then were subject to the same methanol trituration for 3 times. The chemical yields are reported in Table 4.

TABLE 3
Reaction Conditions

| | Theoretical | Theoretical | % of soft | % initiator/ | % initiator/ | reaction | reaction |
|---|---|---|---|---|---|---|---|
| | Styrene | soft block | block that | CTA in | CTA in soft | temperature for | temperature |
| Example | Block MW | MW | is styrene | styrene block | block | styrene block | for soft block |
| 155 | 15000 | 35000 | 0 | 15 | 10 | 60 | 40 |
| 156 | 15000 | 35000 | 10 | 15 | 10 | 60 | 40 |
| 157 | 15000 | 35000 | 20 | 15 | 10 | 60 | 40 |
| 158 | 15000 | 35000 | 30 | 15 | 10 | 60 | 40 |
| 159 | 15000 | 35000 | 0 | 15 | 30 | 60 | 40 |
| 160 | 15000 | 35000 | 10 | 15 | 30 | 60 | 40 |
| 161 | 15000 | 35000 | 20 | 15 | 30 | 60 | 40 |
| 162 | 15000 | 35000 | 30 | 15 | 30 | 60 | 40 |
| 163 | 15000 | 35000 | 0 | 15 | 10 | 60 | 50 |
| 164 | 15000 | 35000 | 10 | 15 | 10 | 60 | 50 |
| 165 | 15000 | 35000 | 20 | 15 | 10 | 60 | 50 |
| 166 | 15000 | 35000 | 30 | 15 | 10 | 60 | 50 |
| 167 | 15000 | 35000 | 0 | 15 | 30 | 60 | 50 |
| 168 | 15000 | 35000 | 10 | 15 | 30 | 60 | 50 |
| 169 | 15000 | 35000 | 20 | 15 | 30 | 60 | 50 |
| 170 | 15000 | 35000 | 30 | 15 | 30 | 60 | 50 |
| 171 | 15000 | 0 | | 15 | | 60 | |
| 172 | 15000 | 0 | | 15 | | 60 | |

TABLE 4
Results

| | Total | | | | |
|---|---|---|---|---|---|
| | Monomer | | | | |
| | conversion | | | | Hydrogenation |
| | based on % | | | | conversion |
| Example | solids | Rh (nm) | Mn | PDI | (%) |
| 155 | 58 | 24.2 | 31320 | 1.22 | 99 |
| 156 | 59 | 26.5 | 33366 | 1.21 | 70 |
| 157 | 63 | 21.4 | 36392 | 1.21 | 65 |
| 158 | 76 | 29.4 | 48683 | 1.34 | 90 |
| 159 | 68 | 26.0 | 40354 | 1.43 | 92 |
| 160 | 69 | 34.0 | 44785 | 1.48 | 55 |
| 161 | 77 | 32.2 | 51804 | 1.52 | 99 |
| 162 | 83 | 29.9 | 58668 | 1.57 | 92 |
| 163 | 67 | 25.7 | 43107 | 1.5 | 80 |
| 164 | 85 | 30.5 | 60687 | 3.5 | 81 |
| 165 | 90 | 28.9 | 66471 | 3.41 | 97 |
| 166 | 75 | 32.7 | 50558 | 5.04 | 75 |
| 167 | 78 | 27.1 | 48493 | 2.23 | 99 |
| 168 | 90 | 31.2 | 65316 | 4.41 | 98 |
| 169 | 94 | 30.8 | 57324 | 5.33 | 86 |
| 170 | 96 | 27.8 | 47793 | 2.57 | 91 |
| 171 | 85 | 18.3 | 9225 | 1.16 | |
| 172 | 99 | 18.5 | 13970 | 1.24 | |

### Example 173

### Cross-Cut Adhesion Test (ASTM D-3359, ISO 2409)

A low-density polyethylene sheet 1/16″ in nominal thickness (US Plastic Corporation, Lima, Ohio) was cut into sections approximately 8 cm×15.2 cm and washed with acetone to clean the surface immediately prior to use.

A polyethylene-poly(vinyl acetate) block copolymer containing 53 wt % polyethylene with a poly(vinyl acetate) number-average molecular weight of 24,000 g/mol was prepared using the method described in Examples 3 through 146 above. The material was dissolved in toluene at 72° C. at a concentration of 10 mg/ml and maintained at this temperature to prevent precipitation of the material.

A thin film of the block copolymer was deposited on the LDPE sheet by placing the cleaned sheet in an oven at 40° C. for 3 minutes, removing the sheet from the oven to a room temperature surface, depositing approximately 300 μl of hot block copolymer solution at one edge of the sheet, and immediately drawing this solution across the sheet with a wire-wound rod (type WC-14; Leneta; Mahwah, N.J.) to create a thin film with a nominal wet film thickness of 24 μm. The solution was permitted to dry at room temperature and 50% relative humidity for 15 minutes by which all of the toluene had visibly evaporated from the surface of the sheet. The sheet was then annealed in a convection oven for 4 minutes at 120° C., removed from the oven to a room temperature surface, and permitted to cool to room temperature over a 30 minute period.

A second coating was then applied to the treated surface of the sheet by depositing approximately 1.5 ml of an alkyd paint (Kel-Guard 1700-69, Gloss Alkyd Rust Inhibitive Enamel; Kelly Moore, San Carlos, Calif.) on one edge of the sheet and using a doctor blade to draw the paint into a layer 100 μm in wet thickness. The paint was allowed to dry at room temperature and 50% relative humidity for 15 to 18 hours.

Crosscut tests were performed using a kit supplied by Precision Gage and Tool Co. in Dayton, Ohio. A set of parallel lines spaced ¼″ apart with a total width of 1″ was scribed through the coating to the substrate. A second set of lines was scribed in the same manner perpendicular to the first set to form a square cross cut region. A strip of 1″ wide pressure-sensitive adhesive tape (P-99; Permacel, New Brunswick. N.J.) was applied to the cross cut region, gently rubbed against the coating to force the tape to conform to the coating, and permitted to rest for 90s to form an adhesive bond with the coating. The tape was then peeled from the coating at a 180° angle. The painted surface of the sheet was then digitized at 300 dpi by a reflective scanner, and the fraction of paint removed from each cross cut region was calculated from image analysis of the cross cut region. This fraction was then used to assign an adhesion rating to each coating paint-combination as described in the following table.

| % of painted | |
|---|---|
| area removed | Adhesion rating |
| None | 5B |
| Less than 5% | 4B |
| 5 to 15% | 3B |
| 15 to 35% | 2B |
| 35 to 65% | 1B |
| More than 65% | 0B |

The polyethylene sheet initially coated with the block copolymer did not exhibit any removal of paint from the cross-cut region and was assigned a rating of 5B. For comparison, a cleaned polyethylene sheet was coated with alkyd paint as described above and characterized in the identical manner. All of the paint was removed from the cross-cut region in the second sheet, resulting in a rating of 0B.

### Example 174

### Surface Energy Measurement

A low-density polyethylene sheet 1/16″ in nominal thickness (US Plastic Corporation, Lima, Ohio) was cut into sections approximately 8 cm×15.2 cm and washed with methanol to clean the surface immediately prior to use. The block copolymer solution described in Example 146 was used as described in that Example to coat one side of a cleaned section of LDPE sheet. A second section was cleaned but left uncoated.

The surface energy of both sheets was estimated from the highest liquid surface tension that was observed to wet the sheet. A series of liquids with known surface tensions (Con-Trol-Cure Dyne Pens; UV Process Supply, Chicago, Ill.) were obtained in the form of preloaded pens and used to draw parallel lines on the surface of a coated sheet. Each pen tip was first saturated with liquid by pressing against a clean porous substrate and then drawn in a single pass across the coated sheet. Liquids which wet the sheet produced uniform lines; liquids which failed to wet the sheet produced lines which contracted or broke apart into a series of disconnected beads upon application. The surface energy of the surface was identified as the surface tension of the liquid which wet the sheet for 1 to 3 seconds before any dewetting was observed.

For the sheet coated with block copolymer, liquids with nominal surface tensions of 40, 44, 48, 50, 52, and 54 mN/m created lines, which wet the sheet for more than 3 seconds. Liquids with nominal surface tensions of 56 and 58 mN/m created lines which initially wet the sheet, but then developed “tears” at the edges of the lines within 3 seconds. Such “tears” are indicative of dewetting. A liquid with a nominal surface tension of 60 mN/m failed to wet the sheet at all, but instead broke up into a series of discrete droplets upon application. Based on these results, the coated sheet was assigned a surface energy of 57±3 mN/m.

For the uncoated sheet, only the liquid with a nominal surface energy of 30 mN/m created a line which wet the sheet for more than 3 seconds. The liquid with a nominal surface energy of 32 mN/m created a line which wet the sheet for 1 to 3 seconds before developing “tears” indicative of dewetting, whereas liquids with values of 34 and 36 mN/m failed to wet the sheet for at least 1 second. The uncoated sheet was therefore assigned a surface energy of 32±2 mN/m.

It is to be understood that the above description is intended to be illustrative and not restrictive. Many embodiments will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated herein by reference for all purposes.

1. A method of preparing a block copolymer having at least one hydrophilic block and one olefinic block comprising polymerizing a liquid hydrophilic monomer under polymerization conditions in the presence of a dithio-containing control agent to create said at least one hydrophilic block and subsequently reacting said at least one hydrophilic block with an olefin monomer capable of free radical polymerization under polymerization conditions to form said at least one olefinic block,
wherein said block copolymer can change the surface tension of an olefinic substrate by an amount of at least 10 mN/m.

2. The method of claim 1, wherein said at least one hydrophilic block is prepared from vinyl acetate monomer.

3. The method of claim 1, wherein said at least one hydrophilic block is prepared from an acrylic monomer.

4. The method of claim 1, wherein said at least one olefinic block is prepared from ethylene.

5. The method of claim 1, wherein said at least one olefinic block is prepared from butadiene.

6. The method of claim 1, further comprising at least partially hydrogenating said olefinic block.

7. The method of claim 1, wherein said block copolymer can cause a LDPE substrate to have a classification of at least 3B on the cross cut adhesion test when coated on the substrate.

8. The method of claim 1, wherein said polymerization conditions during the polymerization of the olefinic block allow for control of the molecular weight of said olefinic block.

9. The method of claim 1, wherein said polymerization conditions during the polymerization of the at least one hydrophilic block allow for control of the molecular weight of said hydrophilic block.

10. A block copolymer prepared by the method of claim 1.

11. A block copolymer of polyethylene and polyvinyl acetate prepared by the method of claim 1.

12. A method of preparing a block copolymer having at least one hydrophilic block and one olefinic block comprising polymerizing an olefinic monomer under free radical polymerization conditions in the presence of a dithio-containing control agent to create said at least one olefinic block and
subsequently reacting said at least one olefinic block with a hydrophilic monomer capable of free radical polymerization under polymerization conditions to form said at least one hydrophilic block.

13. The method of claim 12, wherein said at least one hydrophilic block is prepared from an acrylic monomer.

14. The method of claim 12, wherein said at least one hydrophilic block is prepared from vinyl acetate monomer.

15. The method of claim 12, wherein said at least one olefinic block is prepared from butadiene.

16. The method of claim 12, further comprising at least partially hydrogenating said olefinic block.

17. The method of claim 1, wherein said block copolymer can cause a LDPE substrate to have a classification of at least 3B on the cross cut adhesion test when coated on the substrate.

18. The method of claim 12, wherein said polymerization conditions during the polymerization of the olefinic block allow for control of the molecular weight of said olefinic block.

19. The method of claim 12, wherein said polymerization conditions during the polymerization of the at least one hydrophilic block allow for control of the molecular weight of said hydrophilic block.

20. A block copolymer prepared by the method of claim 12.

21. A block copolymer of polybutadiene and polyethyl acrylate prepared the method of claim 12.

22. A method of preparing a block copolymer having at least one hydrophilic block and the structure A-R, wherein R represents a random block comprising at least two monomers, the method comprising polymerizing a hydrophilic monomer under free radical polymerization conditions in the presence of a dithio-containing control agent to create said at least one hydrophilic block and subsequently reacting said at least one hydrophilic block with at least one olefinic monomer and one monomer that is hydrophilic with respect to the olefinic monomer capable of free radical polymerization under polymerization conditions to form said at least one random block, and at least partially hydrogenating said random block.
